(19) United States
(12) Patent Application Publication
(10) Pub. No.: US 2021/0262912 A1
(43) Pub. Date: Aug. 26, 2021

(54) METHOD FOR DETERMINING THE AVERAGE FILAMENT LENGTH DURING A ROTATIONAL ATOMIZATION, AND SCREENING METHOD BASED THEREON DURING THE DEVELOPMENT OF A PAINT

(71) Applicant: BASF Coatings GmbH, Münster (DE)

(72) Inventors: Daniel Briesenick, Muenster (DE); Dirk Eierhoff, Muenster (DE); Georg Wigger, Muenster (DE); Christian Bornemann, Muenster (DE); Siegfried Riediger, Drensteinfurt (DE); Norbert Willenbacher, Kirchheimbolanden (DE); Walter Oswald, Karlsruhe (DE)

(21) Appl. No.: 17/255,620

(22) PCT Filed: Jun. 24, 2019
(86) PCT No.: PCT/EP2019/066663

§ 371 Date: Dec. 23, 2020

(30) Foreign Application Priority Data
Jun. 25, 2018 (EP) 18179596.4

(51) Int. Cl. G01N 15/02; C09D 175/12; C09D 133/08; B05B 5/04; B05B 5/043; B05B 12/08

(52) U.S. Cl. CPC G01N 15/0227; C09D 175/12; C09D 133/08; C08K 3/105; B05B 5/043; B05B 12/082; B05B 5/0407

(57) ABSTRACT

Described here is a method for determining the mean length of filaments formed on rotational atomization of a coating material composition, the method including atomization of the coating material composition by means of a rotational atomizer including as application element a bell cup capable of a rotation (1), optical capture of the filaments formed here at the bell cup edge, by means of at least one camera (2), and digital evaluation of the optical data obtained in this way, to give the mean filament length of those filaments formed on atomization that are located at the edge of the bell cup (3), as well as methods for compiling an electronic database and for screening coating material compositions when developing paint formulations.

The present invention relates to a method for determining the mean length of filaments formed on rotational atomization of a coating material composition, which comprises at least the steps (1) to (3), specifically atomization of the coating material composition by means of a rotational atomizer comprising as application element a bell cup capable of a rotation (1), optical capture of the filaments formed here at the bell cup edge, by means of at least one camera (2), and digital evaluation of the optical data obtained in this way, to give the mean filament length of those filaments formed on atomization that are located at the edge of the bell cup (3), and also to methods for compiling an electronic database and for screening coating material compositions when developing paint formulations, carried out on the basis of the aforesaid method.

### PRIOR ART

Nowadays in the automobile industry in particular there are a range of coating material compositions, such as basecoat materials, that are applied by means of rotational atomization to the particular substrate that is to be coated. Such atomizers feature a fast-rotating application element such as a bell cup, for example, which atomizes the coating material composition to be applied, atomization taking place in particular by virtue of the acting centrifugal force, forming filaments, to produce a spray mist in the form of drops. The coating material composition is typically applied electrostatically, in order to maximize application efficiency and minimize overspray. At the edge of the bell cup, the coating material, atomized by means of centrifugal forces in particular, is charged by direct application of a high voltage to the coating material composition for application (direct charging). Following application of the respective coating material composition to the substrate, the resultant film—where appropriate following additional application of other coating material compositions over it, in the form of further films—is cured or baked to give the resultant desired coating.

Optimization of coatings, especially coatings obtained in this way, with regard to particular desired properties of the coating, such as prevention of or at least reduction in the tendency for formation and/or the incidence of optical defects and/or surface defects such as, for example, pinholes, cloudiness, and/or in the leveling properties, is comparatively complicated and is typically only possible by empirical means. This means that such coating material compositions or, typically, entire test series thereof, within which different parameters have been varied, must first be produced and then, as described in the preceding paragraph, must be applied to a substrate and cured or baked. After that, the series of coatings then obtained must be investigated with regard to the desired properties, in order to allow any possible improvement in the properties investigated to be assessed. Typically, this procedure has to be multiply repeated with further variation of parameters, until the desired improvement in the property or properties of the coating investigated, after curing and/or baking, has been achieved.

It is known practice in the prior art to investigate and to characterize the coating material compositions used for producing such coatings on the basis of their shear viscosity behavior (shear rheology) to provide a better understanding of their particular application characteristics. Here it is possible to make use, for example, of capillary rheometers. A disadvantage of this procedure, focused on investigation of the shear rheology, however, is that it fails to take account, or to take adequate account, of the quite significant influence of the extensional viscosity that occurs in the course of the rotational atomization (extensional rheology). The extensional viscosity is a measure of the flow resistance of a material in an extensional flow. Such extensional flows occur typically, in addition to the shear flows, in all technical processes that are relevant in this regard, as in the case, for example, of capillary inlet and capillary outlet flows. In the case of a Newtonian flow behavior, the extensional viscosity can be calculated from its constant ratio to the conventionally determined shear viscosity (Trouton ratio). In the case of a non-Newtonian flow behavior, which in practice, across a swathe of applications, occurs with far greater frequency, on the other hand, it is typically necessary for the extensional viscosity, as a parameter independent of the shear viscosity, to be determined experimentally with the aid of an extensional rheometer, for adequate consideration of the extensional rheology in the aforesaid description and characterization. Particularly when the aforesaid rotational atomization method is being carried out, the extensional viscosity may have a quite significant influence on the atomization process and on the breakdown of the filaments into drops which then form the spray mist. Techniques for determining the extensional viscosity are known in the prior art. It is typical here to determine the extensional viscosity by means of Capillary Breakup Extensional Rheometers (CaBERs). To date, however, there has been no available technique for giving adequate consideration equally to both extensional forces and shearing forces, without actually atomizing the material under investigation.

There is therefore a need for a method which makes it possible, by investigating the atomization behavior of coating material compositions, to achieve an improvement in certain desired properties of the coatings to be produced by means of this atomization, such as the prevention of or at least reduction in the tendency for formation and/or the incidence of optical defects and/or surface defects, without having to go through the commonly required complete operation of coating and baking for producing such coatings. Equally, however, such a method should take account not only, adequately, of the shear rheology it entails, but also of the extensional rheology.

### PROBLEM

A problem addressed by the present invention, therefore, is that of providing a method which makes it possible to investigate and more particularly to improve certain desired properties of coatings to be produced by rotational atomization, such as the prevention of or at least reduction in the tendency for formation and/or the incidence of optical defects and/or surface defects, without having to apply the respective coating material composition for use to a substrate by means of a conventional painting process and in particular without having to cure and/or bake the resulting film in order to produce the coating, since to do so is comparatively costly and inconvenient and is disadvantageous at least on economic grounds. Such a method ought equally to take adequate account of the extensional behavior that occurs in the course of the atomization. A particular problem addressed by the present invention is that of providing such a method for aqueous basecoat materials as coating material compositions.

### SOLUTION

This problem is solved by the subject matter claimed in the claims and also by the preferred embodiments of that subject matter that are described in the description hereinafter.

A first subject of the present invention is a method for determining the mean length of filaments formed on rotational atomization of a coating material composition, comprising at least the steps (1) to (3), specifically

(1) atomization of the coating material composition by means of a rotational atomizer comprising as application element a bell cup capable of a rotation,

(2) optical capture of the filaments formed on atomization as per step (1) at the bell cup edge, by means of at least one camera, and

(3) digital evaluation of the optical data obtained by the optical capture as per step (2), to give the mean length of those filaments formed on atomization that are located at the edge of the bell cup.

It has surprisingly been found that the method of the invention allows the rotational atomization behavior of a wide variety of different coating material compositions, and especially of aqueous basecoat materials, to be investigated and characterized. This is accomplished, surprisingly, on the basis of the determination of the mean lengths of those filaments that occur on atomization that are located at the edge of the bell cup when the latter is used as a rotating application element during rotational atomization.

The mean filament lengths that are determined by means of the method of the invention can be incorporated into an electronic database, or such a database can be compiled and/or updated. A second subject of the present invention is therefore a method for compiling and/or updating an electronic database containing mean filament lengths of atomized coating material compositions which differ from one another, the method comprising at least steps (1) to (3), (4A), and (5A), specifically

steps (1), (2), and (3) as per the method of the invention for determining the mean filament length for a first coating material composition (i),

(4A) incorporation of the mean filament length, ascertained as per step (3) for the first coating material composition (i), into an electronic database, and

(5A) repetition at least once of the steps (1) to (3) and (4A) for at least one further coating material composition, different from the first coating material composition (i).

The incorporation of the ascertained mean filament length into the database as per step (4A) preferably further includes the incorporation into the database of the respective standard deviations of the mean filament lengths respectively determined.

When the methods of the invention are implemented, the influence of the extensional viscosity that occurs on rotational atomization of coating material compositions which can be employed for producing coatings is adequately considered. This is so in particular because, when the methods of the invention are implemented, comparatively high extension rates are considered, namely extension rates of up to 100 000 s⁻¹, and hence extension rates higher than those in the case of conventional CaBER measurements for determining the extensional viscosity, for which, especially in the case of basecoat materials, only extension rates of up to 1000 s⁻¹ are achieved, and the determination of the mean filament lengths therefore takes place at aforesaid comparatively high extension rates. By means of the methods of the invention, in contrast to conventional CaBER methods, even if the bell cup on rotational atomization is set at only a comparatively low rotary speed (rotational velocity), a higher extensional viscosity and higher extension rates that occur are achieved and considered. The methods of the invention, moreover, make it possible to give consideration to transverse flows which occur—in addition to shear rates and extension rates—in the course of a rotational atomization. Such transverse flows are not considered in any of the customary, known methods for investigating the shear rheology or extensional rheology. As a result of the fact that the methods of the invention, with step (1), themselves include the implementation of a rotational atomization, it is possible to give consideration not only to shear rheology and to extensional rheology but also to the incidence of transverse flows within a single method, sufficiently, and not using techniques which are able to capture only individual elements (shear rheology or extensional rheology).

It has further been surprisingly found that, particularly in the case of aqueous basecoat materials which are used as coating material compositions in the rotational atomization, pigments present therein, especially effect pigments such as aluminum effect pigments, as their fraction increases, relative to the total weight of the basecoat material, lead to a shortening in the length of the filaments (in other words to lower mean filament lengths) of at least those filaments occurring in the atomization that are located at the edge of the bell cup. Lower mean filament lengths result in a shorter lifetime of these filaments at the bell cup edge. Such lower mean filament lengths in turn denote a “finer” atomization of the coating material composition used. Maximally fine atomization is desirable since it entails a lower wetness, in other words a less wet appearance to the film formed after application of the coating material composition used. The skilled person is aware that too great a wetness can lead to unwanted incidence of pops and/or pinholes, to a poorer shade and/or flop, and/or to the incidence of cloudiness. This technical effect, i.e., the incidence of filaments with a lower mean filament length, located at the edge of the bell cup, as the pigment fraction in the coating material composition goes up, and the associated advantageous properties such as a reduced wetness, is all the more surprising because, by means of comparative CaBER measurements of the same coating material compositions, as the pigment fraction increases, a longer lifetime of these filaments and hence higher mean filament lengths had been determined, supposed in turn to result in an unwanted higher wetness. Investigations of the wetness of films obtained using the coating material compositions have, however, confirmed the results in respect of wetness that are obtained by means of the method of the invention. This shows that the results obtained by means of the method of the invention correspond more highly to the actual conditions than the results obtained on the basis of comparative CaBER measurements. In other words, a reliance solely on CaBER measurements may lead to incorrect assessment of the circumstances actually occurring in practice, and more particularly to an incorrect behavior which is contrary on the basis of the result obtained by means of the method of the invention.

Surprisingly, by implementing the method of the invention on the basis of the mean filament lengths ascertained, it is possible to achieve an investigation of and in particular an improvement in certain desired properties of coatings to be produced by means of rotational atomization, particularly with regard to preventing or at least reducing the tendency for formation and/or the incidence of optical defects and/or surface defects, without in this case having to apply the particular coating material composition for use to a substrate by means of a conventional painting procedure and to carry out curing and/or baking of the resulting film in order to produce the coating.

A further subject of the present invention is therefore a method for screening coating material compositions in the development of paint formulations, which comprises at least steps (1) to (3), (4B), (5B), and (6B), and also optionally (7B), where within the steps (1) to (3) first of all the mean length is determined of filaments formed on rotational atomization of a coating material composition (X1), in accordance with the method of the invention described above for determining the mean filament length. These steps (1) to (3) therefore correspond to steps (1) to (3) of the first subject of the present invention.

The method for screening coating material compositions in the development of paint formulations comprises at least the steps (1) to (3), (4B), (5B), and (6B), and also optionally (7B), namely

(1) atomization of a coating material composition (X1) by means of a rotational atomizer comprising as application element a bell cup capable of a rotation,

(2) optical capture of the filaments formed on atomization as per step (1) at the bell cup edge, by means of at least one camera,

(3) digital evaluation of the optical data obtained by the optical capture as per step (2), to give the mean length of those filaments formed on atomization that are located at the edge of the bell cup,

(4B) comparison of the mean filament length, determined as per step (3) for the coating material composition (X1), with mean filament lengths of further coating material compositions, stored in an electronic database, said database being obtainable by means of the aforesaid method of the invention for compiling and/or updating an electronic database (second subject of the present invention),

(5B) checking, on the basis of the comparison as per step (4B), as to whether the mean filament length, determined as per step (3) for the coating material composition (X1), meets the condition that it is lower than at least one mean filament length stored in the database of a coating material composition (X2), which is different from the coating material composition (X1) but has a pigment content identical to that of the coating material composition (X1) or has a pigment content deviating by no more than ±10% by weight from the pigment content of the coating material composition (X1), based on the amount of pigment present in the coating material composition (X1), and which, moreover, comprises the identical pigment or pigments or the substantially identical pigment or pigments to the coating material composition (X1),

(6B) selection of the coating material composition (X1) for application to a substrate, if the mean filament length determined for the coating material composition (X1) meets the condition specified in step (5B),

or

adaptation of at least one parameter within the formula of the coating material composition (X1) and/or of at least one method parameter when performing steps (1) to (3) of the method for screening coating material compositions, if the mean filament length determined for the coating material composition (X1) does not meet the condition specified in step (5B),

(7B) repetition at least once of steps (1) to (3), (4B), and (5B), if as per step (6B) at least one parameter adaptation has been required, until, according to an implementation of step (6B), repeated at least once, owing to the meeting of the condition stated in step (5B), according to step (6B), the coating material composition used is selected for application to a substrate.

It has surprisingly been found that the method of the invention for screening coating material compositions in the development of paint formulations is less costly and inconvenient than typical methods and therefore has (time-)economic and financial advantages over corresponding conventional methods. By means of the method of the invention it is possible surprisingly, on the basis of the ascertained mean filament lengths, to estimate, with a sufficiently high probability, whether certain optical defects and/or surface defects can be expected in the coating to be produced, without producing the coating at all, especially in the case of aqueous basecoat materials. This is accomplished, surprisingly, by determination of the mean lengths of the filaments which occur on atomization, located at the edge of the bell cup of the rotational atomizer, and by a correlation of these ascertained filament lengths with the incidence of the aforesaid optical defects and/or surface defects, or their prevention/reduction. Depending on these mean filament lengths occurring during atomization, it is possible accordingly to be able to monitor the resulting properties such as optical properties and/or surface properties of the coating to be produced and in particular to prevent or at least reduce the incidence of optical defects and/or surface defects. In other words, by means of the method of the invention, because of the investigation of the atomization behavior of a coating material composition, it is possible to make predictions regarding qualitative properties of the eventual coating (such as the incidence of pinholes, cloudiness, leveling, or appearance). In particular it has surprisingly been found that they correlate with these properties better than other techniques known from the prior art, such as CaBER measurements. The method of the invention therefore permits a simple and efficient technique for quality assurance and enables purposive development of coating material compositions without need for recourse to comparatively costly and inconvenient coating procedures on (model) substrates. In particular it is possible here to omit the step of curing and/or baking.

### DETAILED DESCRIPTION

### Method of the Invention for Determining the Mean Filament Length

A first subject of the present invention is a method for determining the mean length of filaments formed on rotational atomization of a coating material composition, which comprises at least steps (1) to (3).

The concept of “rotational atomizing” or of “high-speed rotational atomizing” is one which is known to the skilled person. Such rotational atomizers feature a rotating application element that atomizes the coating material composition to be applied into a spray mist in the form of drops, owing to the acting centrifugal force. The application element in this case is a preferably metallic bell cup.

In the course of rotational atomization by means of atomizers, so-called filaments develop first, at the edge of the bell cup, and then go on, in the further course of the atomization process, to break down further into aforesaid drops, which then form a spray mist. The filaments therefore constitute a precursor of these drops. The filaments may be described and characterized by their filament length (also referred to as “thread length”) and their diameter (also referred to as “thread diameter”).

When the method of the invention is carried out, sufficient consideration is given to the extensional viscosity which occurs during the rotational atomization. The skilled person is aware of the concept of extensional viscosity ne, with the unit pascal-second (Pa·s), as a measure of the flow resistance of a material in an extensional flow. Techniques for determining the extensional viscosity are likewise known to the skilled person. The extensional viscosity is typically determined here using what are called Capillary Breakup Extensional Rheometers (CaBERs), which are sold by Thermo Scientific, for example. Comparatively high values for the extensional viscosity (i.e., comparatively high extension resistances) ascertained by means of corresponding CaBER measurements imply relatively high stability of the filaments which are formed on atomization. The greater, in turn, the stability of the filaments, the longer the average lifetime of the filaments occurring in the atomization (also referred to as thread lifetime), before they break down further into drops which then form the spray mist. A comparatively high average filament lifetime of this kind is customarily associated in turn with a higher mean length of these filaments. A technique for determining the thread lifetime, in other words the lifetime of a filament, in an extension experiment by means of a CaBER measurement is indicated hereinafter within the methodological description.

### Step (1)

Step (1) of the method of the invention relates to an atomization of the coating material composition used by means of a rotational atomizer having as application element a bell cup which is capable of a rotation. Here, optionally, the atomized coating material composition may undergo electrostatic charging at the edge of the bell cup by the application of a voltage. This is not necessary, however, for the implementation of the method of the invention, particularly for the implementation of step (1) of the method of the invention.

The speed of rotation (rotational velocity) of the bell cup is adjustable. In the present case the rotation speed is preferably at least 10 000 revolutions/min (rpm) and at most 70 000 revolutions/min. The rotational velocity is preferably in a range from 15 000 to 70 000 rpm, more preferably in a range from 17 000 to 70 000 rpm, more particularly from 18 000 to 65 000 rpm or from 18 000 to 60 000 rpm. At a rotation speed of 15 000 revolutions per minute or above, a rotational atomizer of this kind, in the sense of this invention, is referred to preferably as a high-speed rotational atomizer. Rotational atomization in general and high-speed rotational atomization in particular are widespread within the automobile industry. The (high-speed) rotational atomizers used for these processes are available commercially; examples include products of the Ecobell® series from the company Dürr. Such atomizers are suitable preferably for electrostatic application of a multiplicity of different coating material compositions, such as paints, that are used in the automobile industry. Particularly preferred for use as coating material compositions within the method of the invention are basecoat materials, more particularly aqueous basecoat materials. The coating material composition may be applied electrostatically, but need not be. In the case of electrostatic application, there is electrostatic charging of the coating material composition, atomized by centrifugal forces, at the bell cup edge, by preferably direct application of a voltage such as a high voltage to the coating material composition that is to be applied (direct charging).

The discharge rate of the coating material composition to be atomized, during the implementation of step (1), is adjustable. The discharge rate of the coating material composition for atomization, during the implementation of step (1), is preferably in a range from 50 to 1000 ml/min, more preferably in a range from 100 to 800 ml/min, very preferably in a range from 150 to 600 ml/min, more particularly in a range from 200 to 550 ml/min.

The discharge rate of the coating material composition for atomization, during the implementation of step (1), is preferably in a range from 100 to 1000 ml/min or from 200 to 550 ml/min, and/or the rotary speed of the bell cup is in a range from 15 000 to 70 000 revolutions/min or from 15 000 to 60 000 rpm.

The coating material composition used in step (1) of the method of the invention is preferably a basecoat material, more preferably an aqueous basecoat material, more particularly an aqueous basecoat material which comprises at least one effect pigment.

### Step (2)

Step (2) of the method of the invention sees the filaments formed on atomization as per step (1) at the bell cup edge being captured optically by means of at least one camera.

In other words, within step (2) of the method of the invention, the atomization process is captured optically as per step (1) at the bell cup edge of the bell cup of the bell, being more particularly photographed, and/or a corresponding video recording is prepared. In this way, information about the decomposition of filaments formed directly at the bell cup edge during the atomization can be obtained.

The camera used to implement step (2) is preferably a high-speed camera. Examples of such cameras are models from the Fastcam® range from Photron Tokyo, from Japan, such as the Fastcam® SA-Z model, for example.

The optical capture as per step (2) is accomplished preferably by the at least one camera recording 30 000 to 250 000 images per second, more preferably 40 000 to 220 000 images per second, more preferably still 50 000 to 200 000 images per second, very preferably 60 000 to 180 000 images, even more preferably 70 000 to 160 000 images per second, and more particularly 80 000 to 120 000 images per second, of the bell cup and more particularly of the bell cup edge. The resolution of the images may be set variably. For example, resolutions of 512×256 pixels per image are possible.

### Step (3)

Step (3) of the method of the invention provides for digital evaluation of the optical data obtained by the optical capture as per step (2). The aim of this digital evaluation is to determine the mean length of those filaments formed directly on the bell cup margin during the atomization, namely at the bell cup edge.

The digital evaluation as per step (3) may be accomplished by means of image analysis and/or video analysis of the optical data obtained as per step (2), such as the images and/or videos recorded by the camera within step (2).

Step (3) is preferably carried out with support from software such as a MATLAB® software based on a MAT LAB® code.

The digital evaluation as per step (3) preferably encompasses two or more stages of an image and/or video processing of the optical data obtained as per step (2). Preferably at least 1000 images, more preferably at least 1500 images, very preferably at least 2000 images, of the images recorded in step (2) are used as the optical data basis for the digital evaluation as per step (3).

The ascertainment of the mean filament length as per step (3) preferably includes the standard deviations of the mean filament lengths.

Step (3) is preferably carried out in multiple stages.

The digital evaluation as per step (3) takes place preferably in at least six stages (3a) to (3f), specifically

(3a) smoothing of the images obtained as optical data after implementation of step (2), by means of a Gaussian filter, to remove the bell cup from the images,

(3b) binarization and inverting of the images smoothed as per stage (3a),

(3c) binarization of the images used in stage (3a) and addition of the images thus binarized to the inverted images from stage (3b), to give binarized images without bell cup edge, and inverting of the images thus obtained,

(3d) removal of drops, fragmented filaments, and filaments not located at the bell cup edge from the images obtained as per stage (3c), to give images on which all of the located objects remaining are filaments,

(3e) removal, from the images obtained as per stage (3d), of those filaments not located entirely within the images, and

(3f) tapering of all filaments remaining in the images after stage (3e) to their number of pixels, addition of the number of pixels for each of the filaments, determination of the filament length of each of the filaments on the basis of the pixel size, and ascertainment of the mean filament length for the entirety of all filaments measured.

The removal as per stage (3d) is preferably accomplished by (i) determination of the length of all hypotenuses of all objects located on the images, (ii) labeling of objects as drops and/or fragmented filaments on the images if the hypotenuse values ascertained for these objects fall below a defined value h, and elimination of these objects, and (iii) verification of the remaining objects, namely the filaments, on the basis of their position on the images, as to whether they were located at the bell cup edge, and elimination of those filaments to which this does not apply. The value h here corresponds to 15 pixels (or 300 μm).

The individual stages are elucidated in more detail below.

In a first stage (3a), the bell cup is preferably removed within the respective images recorded and used as the basis for the digital evaluation. For this purpose, a Gaussian filter is used to smooth each image to such an extent that the entire bell cup, more particularly the entire bell, is no longer visible.

In a second stage (3b), the images thus smoothed are preferably binarized and inverted.

In a third stage (3c), the original images as well, i.e., the images used in stage (3a), are preferably binarized and are added together with the inverted images from stage (3b). As a result, a binarized series of images is obtained, without bell edge, and this series of images is in turn preferably inverted for further evaluation.

The binarization takes place in each case in particular in order more effectively to distinguish the filaments for measurement from the background of the pictures.

In a fourth stage (3d), conditions are preferably defined by which filaments can be distinguished from other objects such as drops. Here, first of all, preferably the hypotenuses of all the objects in the respective pictures, including the filaments, are determined, being calculated by means of xₘᵢₙ, xₘₐₓ, yₘᵢₙ, and yₘₐₓ of the objects. The values are obtained by means of a MATLAB function which reports these extreme values, thus for each object the corresponding x value in the x-direction, namely xₘᵢₙ and xₘₐₓ, and for each object the corresponding y value in the y-direction, namely yₘᵢₙ and yₘₐₓ. The hypotenuses of the objects must be greater than a particular value h for the object thereof to be seen as being a filament. The value h here corresponds to 15 pixels (or 300 μm). Consequently, all smaller objects, such as drops, are no longer considered for the ongoing evaluation. Moreover, each object must have a y value which is located in the immediate vicinity of the bell edge (which has already been removed on the images). The y value here corresponds to a value which is located over a defined distance in the y-direction on which each object must reside in order to be deemed to be a filament located at the bell edge. The concept of the “immediate vicinity” in this context comprehends y values which have a distance of not more than 5 pixels from the bell edge and/or a location of at most 5 pixels below the bell edge. Accordingly, all fragments, in particular all relatively long fragments, that are not connected to the bell cup edge are ruled out for the evaluation of the determination of the filament length, and the only filaments considered are those which are located at the bell cup edge.

In a fifth stage (3e), all objects still remaining within the respective pictures after implementation of stage (3d) are preferably verified as to whether their minimum x value is greater than 0 and their maximum x value is less than 256. Only objects meeting this condition are considered in the further course. Hence the only filaments evaluated are those which are located completely within the recorded image frame. All remaining objects in a picture are preferably numbered.

In a sixth stage (3f), all of the objects remaining after stage (3e) are preferably called up individually and tapered preferably by means of the skeleton method. This method is known to the skilled person. As a result, only one pixel of each object is then connected to at most one other pixel. Subsequently, the number of pixels per object or filament is counted together. Because the pixel size is known, the actual length of the filaments can be calculated. This image evaluation evaluates approximately 15 000 filaments per picture. This ensures a high statistical base in the determination of the filament lengths. From the entirety of all filament lengths thus ascertained for the filaments investigated, the mean length of these filaments is then obtained as a result. In this way, the mean length is obtained for those filaments formed on atomization that are located at the bell cup edge of the bell cup.

The method of the invention comprises at least steps (1) to (3), but may optionally also include further steps. Steps (1) to (3) are preferably carried out in numerical order. Steps (1) and (2) are preferably carried out synchronously; in other words, the optical capture as per step (2) takes place preferably during the implementation of step (1).

Method of the Invention for Compiling and/or Updating an Electronic Database

A further subject of the present invention is a method for compiling and/or updating an electronic database containing mean filament lengths of atomized coating material compositions which differ from one another, the method comprising at least steps (1) to (3), (4A), and (5A), specifically

implementation of steps (1), (2), and (3) as per the method of the invention for determining the mean filament length for a first coating material composition (i), i.e.,

(1) atomization of the coating material composition (i) by means of a rotational atomizer comprising as application element a bell cup capable of a rotation,

(2) optical capture of the filaments formed on atomization as per step (1) at the bell cup edge, by means of at least one camera, and

(3) digital evaluation of the optical data obtained by the optical capture as per step (2), to give the mean length of those filaments formed on atomization that are located at the edge of the bell cup,

(4A) incorporation of the mean filament length, ascertained as per step (3) for the first coating material composition (i), into an electronic database, and

(5A) repetition at least once of the steps (1) to (3) and (4A) for at least one further coating material composition, different from the first coating material composition (i).

All preferred embodiments described hereinabove in connection with the method of the invention for determining the mean filament length are also preferred embodiments in relation to the method for compiling and/or updating an electronic database.

The incorporation of the ascertained mean filament length into the database, as per step (4A), preferably also entails, as already observed above, the incorporation of the respective standard deviations into the database. The standard deviation can take adequate account of any inhomogeneity and/or incompatibility occurring in the particular coating material composition used, during the atomization. In the case of such inhomogeneities and/or incompatibilities, the filament lengths may have been subject to substantial fluctuations at regular or irregular intervals: for example, the mean filament lengths ascertained for two different coating material compositions may be identical, but in one case there may be approximately uniform breakdown of the filaments and in another case there may be fluctuations, which in that case are additionally captured by consideration of the standard deviations, this being the reason why it may be advantageous to incorporate the respective standard deviation into the database.

Step (5A) envisions repetition at least once of steps (1) to (3) and (4A) for at least one further coating material composition, different from the first coating material composition (i), such as for at least one second coating material composition (ii).

The repetition as per step (5A) is carried out preferably for a multiplicity of corresponding coating material compositions which are different in each case. The repetition therefore takes place at least once to x times, where x is a positive integer 2. Since the method of the invention is a method for compiling and/or for updating an electronic database, there is no upper limit here on the number of coating material compositions to be used: the higher the number of repetition steps (5A) and/or the higher the number of coating material compositions used within the repetition step (5A), the greater the quantity of information that is incorporated into the database with regard to the mean filament lengths of these compositions that occur during the atomization, and this of course is advantageous. For example, the parameter x may be in the range from 2 to 1 000 000 or from 5 or 10 or 50 or 100 to 1 000 000.

By means of the method of the invention for compiling and/or updating an electronic database, an electronic database of this kind is preferably expanded and updated continuously. This database is then able to furnish information about the mean filament lengths of a multiplicity of different atomized coating material compositions. The electronic database is preferably an online database. Step (4A) is preferably carried out by means of software support.

Incorporated into the database when implementing the method of the invention for compiling and/or updating an electronic database, within step (4A), are preferably not only the ascertained mean filament lengths but also, instead, all method parameters selected and/or mandated for the implementation of steps (1) to (3). In addition to these method parameters or alternatively to them, all product parameters relating to the coating material compositions used in the method of the invention are preferably likewise incorporated into the database, and especially the particular formulas for their preparation and/or the components used for their preparation, and their corresponding amounts.

The at least one further coating material composition used in step (5A), such as at least one coating material composition (ii), is different from the first coating material composition (i). Similarly, all further coating material compositions used in a repetition of step (5A) are different not only from each of the coating material compositions (i) and (ii) but also from one another.

The at least one further coating material composition used in step (5A), such as at least one second coating material composition (ii), preferably has a pigment content identical to that of the first coating material composition (i) or a pigment content which deviates by at most ±10% by weight, more preferably by at most ±5% by weight, from the pigment content of the coating material composition (i), based on the amount of pigment present in the coating material composition (i), and which, moreover, comprises the identical pigment or pigments or the substantially identical pigment or pigments to the coating material composition (i). The same applies, preferably, to each further coating material composition of those used when repeating step (5A): preferably each of these further coating material compositions has a pigment content identical to that of the first coating material composition (i) or a pigment content which deviates by at most ±10% by weight, more preferably by at most ±5% by weight, from the pigment content of the coating material composition (i), based on the amount of pigment present in the coating material composition (i), and which, moreover, comprises the identical pigment or pigments or the substantially identical pigment or pigments to the coating material composition (i). If a defined effect pigment is used in the first coating material composition (i), for example, the identical effect pigment, in the case of identical pigments, is also present as effect pigment in each further one of the coating material compositions used when repeating step (5A), although the amount thereof may vary within the above-stated boundaries.

The method of the invention for compiling an electronic database, besides steps (1) to (3), (4A), and (5A), preferably further comprises at least the further steps (3A), (3B), and (3C), namely

(3A) application of the first coating material composition (i) atomized in step (1) to a substrate, to form a film located on the substrate, and baking of this film to form a coating located on the substrate,

(3B) analysis and assessment of the coating obtained after step (3A) for the incidence or nonincidence of surface defects and/or optical defects, and

(3C) incorporation of the results obtained after implementation of step (3B) into the electronic database,

where step (5A) of the method of the invention in this case comprises the repetition of these steps (3A), (3B), and (3C) for at least one further coating material composition, different from the first coating material composition (i), such as at least one second coating material composition (ii).

In this way, the database compiled by means of the method of the invention preferably includes not only the mean filament lengths determined for the coating material compositions used, such as those of the coating material compositions (i), (ii), and each further coating material composition used, but also, moreover, includes data concerning the assessment of the coatings obtainable from each of these compositions, with regard to the possible incidence of surface defects and/or optical defects. This enables a direct correlation of the mean filament lengths, occurring and determined during the atomization of the compositions, with the incidence or nonincidence of surface defects and/or optical defects in and/or on the coating, within the database. These data can then be called up from the database.

In step (3A) use is preferably made of metallic substrates. Also possible in principle, however, are nonmetallic substrates, especially plastics substrates. The substrates that are used may have been coated. If a metal substrate is to be coated, then, before a surfacer and/or primer-surfacer and/or a basecoat material is applied, the metal substrate is additionally coated, preferably, with an electrocoat. If a plastics substrate is being coated, then, before a surfacer and/or primer-surfacer and/or a basecoat material is applied, the plastics substrate is preferably pretreated. The techniques most commonly employed for such pretreatment are flaming, plasma treatment, and corona discharge. Flaming is employed with preference. The coating material compositions used, such as the coating material compositions (i), (ii), and each further coating material composition used, are preferably basecoat materials, more particularly waterborne basecoat materials. Correspondingly, the coating obtained after step (3A) is preferably a basecoat. The substrate in this case can optionally contain at least one of the aforesaid coatings prior to application of the basecoat material. Application of the basecoat material or materials to a metal substrate in step (3A) may take place at the film thicknesses customary in the context of the automobile industry, in the range from, for example, 5 to 100 micrometers, preferably 5 to 60 micrometers, especially preferably 5 to 30 micrometers. The substrate used preferably has an electrocoat (EC), more preferably an electrocoat applied by cathodic deposition of an electrocoat material. Baking is preferably preceded by drying in accordance with known techniques. For example, (1-component) basecoat materials, which are preferred, can be flashed off at room temperature (23° C.) for 1 to 60 minutes and subsequently dried preferably at possibly slightly elevated temperatures of 30 to 90° C. Flashing off and drying in the context of the present invention refer to the evaporation of organic solvents and/or water, making the paint drier but not yet curing it, or not yet forming a fully crosslinked coating film. Curing, in other words baking, is accomplished preferably thermally at temperatures from 60 to 200° C. The coating of plastics substrates is basically similar to that of metal substrates. Here, however, curing generally takes place at much lower temperatures, of 30 to 90° C. Step (3A), after application of the first coating material composition (i), atomized in step (1), to a substrate, may optionally include the application of a further coating material composition and curing thereof. Especially if the first coating material composition (i) atomized in step (1) is a preferably aqueous basecoat material, it is possible for a commercial clearcoat material to be applied over it by commonplace techniques, in which case the film thicknesses are again within the commonplace ranges, such as 5 to 100 micrometers, for example. After the clearcoat material has been applied, it may be flashed off at room temperature (23° C.) for 1 to 60 minutes, for example, and optionally dried. The clearcoat material is then preferably cured, i.e., baked, together with the applied, atomized first coating material composition (i). Baking is accompanied by crosslinking reactions, for example, to produce a multicoat effect finish, and/or color and effect finish, on a substrate.

In step (3B), preferably, the incidence or nonincidence of surface defects and/or optical defects selected from the group of pinholes, pops, runs and/or cloudiness is investigated and assessed, and/or the appearance (visual aspect) of the coating is investigated and assessed. The coating is preferably a basecoat such as a waterborne basecoat. Incidence of pinholes is investigated and assessed in accordance with the method of determination described hereinafter, by counting of the pinholes on wedge application of the coating to a substrate as per step (3A) in a film thickness range from 0 to 40 μm (dry film thickness), with the ranges from 0 to 20 μm and from >20 to 40 μm being counted separately; standardization of the results to an area of 200 cm²; and summation to give a total number. Preferably just a single pinhole is a defect. Incidence of pops is investigated and assessed in accordance with the method of determination described hereinafter, by determination of the popping limit, i.e., the film thickness of a coating, such as a basecoat, from which pops occur, in accordance with DIN EN ISO 28199-3, section 5 (date: January 2010). With preference just a single pop is a defect. Incidence of cloudiness is investigated and assessed in accordance with the method of determination described hereinafter using the cloud-runner instrument from BYK-Gardner GmbH, with determination of the three characteristic variables of “mottling15”, “mottling45”, and “mottling60” as measures of the cloudiness, measured at the angles of 15°, 45°, and 60° relative to the angle of reflection of the measurement light source used; the higher the value of the corresponding characteristic variable or variables, the more pronounced the cloudiness. Appearance is investigated and assessed in accordance with the method of determination described hereinafter, by assessing the leveling on wedge application of the coating to a substrate as per step (3A) in a film thickness range from 0 to 40 μm (dry film thickness), with different regions, such as 10-15 μm, 15-20 μm, and 20-25 μm, for example, being marked, and with the investigation and assessment being performed within these film thickness regions using the Wave scan instrument from Byk-Gardner GmbH. In that case a laser beam is directed at an angle of 60° onto the surface to be investigated, and over a measuring distance of 10 cm the fluctuations of the reflected light in the short wave region (0.3 to 1.2 mm) and in the long wave region (1.2 to 12 mm) are recorded by means of the instrument (long wave=LW; short wave=SW; the lower the figures, the better the leveling). Incidence of runs is investigated and assessed in accordance with the method of determination described hereinafter, by determination of the running tendency in accordance with DIN EN ISO 28199-3, section 4 (date: January 2010). A defect occurs, preferably, when runs occur starting from a film thickness which is below a film thickness amounting to 125% of the target film thickness. For example, if the target film thickness is 12 μm, a defect occurs if there are runs at a film thickness of 12 μm+25%, in other words at 16 μm. Film thicknesses here are determined in each case in accordance with DIN EN ISO 2808 (date: May 2007), method 12A, preferably using the MiniTest® 3100-4100 instrument from ElektroPhysik. In all cases the thickness in question is the dry film thickness in each case.

The skilled person knows the terms “pinholes”, “pops”, “runs”, and “leveling”, from Römpp Chemie Lexikon, Lacke and Druckfarben, 1998, 10th edition, for example. The concept of cloudiness is likewise one known to the skilled person. The cloudiness of a paint finish is understood according to DIN EN ISO 4618 (date: January 2015) to refer to the disparate appearance of a finish due to irregular regions, distributed randomly over the surface, that differ in their color and/or gloss. A dappled inhomogeneity of this kind is disruptive to the uniform overall impression conveyed by the finish, and is generally undesirable. A method for determining the cloudiness is specified hereinafter.

Method of the Invention for Screening Coating Material Compositions when Developing Paint Formulations

A further subject of the present invention is a method for screening coating material compositions when developing paint formulations.

Steps (1) to (3) of the method for screening coating material compositions when developing paint formulations are identical to steps (1) to (3) of the method for determining the mean length of filaments formed on rotational atomization of a coating material composition. With regard to these steps, therefore, reference is made to the observations above.

The method of the invention for screening coating material compositions when developing paint formulations comprises at least steps (1) to (3), (4B), (5B), and (6B), and also optionally (7B), namely

steps (1), (2), and (3) for a coating material composition (X1), as defined within the method of the invention for determining the mean length of filaments formed on rotational atomization of a coating material composition, therefore

(1) atomization of a coating material composition (X1) by means of a rotational atomizer comprising as application element a bell cup capable of a rotation,

(2) optical capture of the filaments formed on atomization as per step (1) at the bell cup edge, by means of at least one camera,

(3) digital evaluation of the optical data obtained by the optical capture as per step (2), to give the mean length of those filaments formed on atomization that are located at the edge of the bell cup,

(4B) comparison of the mean filament length, determined as per step (3) for the coating material composition (X1), with mean filament lengths of further coating material compositions, stored in an electronic database, said database being obtainable by means of the aforesaid method of the invention for compiling and/or updating an electronic database,

(5B) checking, on the basis of the comparison as per step (4B), as to whether the mean filament length, determined as per step (3) for the coating material composition (X1), meets the condition that it is lower than at least one mean filament length stored in the database of a coating material composition (X2), which is different from the coating material composition (X1) but has a pigment content identical to that of the coating material composition (X1) or has a pigment content deviating by no more than ±10% by weight from the pigment content of the coating material composition (X1), based on the amount of pigment present in the coating material composition (X1), and which, moreover, comprises the identical pigment or pigments or the substantially identical pigment or pigments to the coating material composition (X1),

(6B) selection of the coating material composition (X1) for application to a substrate, if the mean filament length determined for the coating material composition (X1) meets the condition specified in step (5B),

or

adaptation of at least one parameter within the formula of the coating material composition (X1) and/or of at least one method parameter when performing steps (1) to (3) of the method for screening coating material compositions, if the mean filament length determined for the coating material composition (X1) does not meet the condition specified in step (5B),

(7B) repetition at least once of steps (1) to (3), (4B), and (5B), if as per step (6B) at least one parameter adaptation has been required, until, according to an implementation of step (6B), repeated at least once, owing to the meeting of the condition stated in step (5B), the coating material composition used is selected for application to a substrate.

The method of the invention for screening coating material compositions when developing paint formulations therefore allows an adaptation in the sense of a reduction of mean filament lengths, arising during the atomization, of coating material compositions such as the coating material composition (X1), on the basis of and/or in comparison to known mean filament lengths of comparative coating material compositions such as the coating material composition (X2).

The term “substantially identical pigment” is understood in the sense of the present invention in connection with effect pigments to mean that the effect pigment or pigments present in the coating material composition (X1) and that or those present in the coating material composition (X2), as a first condition (i), have an identical chemical composition to an extent of at least 80% by weight, preferably at least 85% by weight, more preferably at least 90% by weight, very preferably at least 95% by weight, more particularly at least 97.5% by weight, based in each case on their total weight, but preferably in each case to an extent of less than 100% by weight. Effect pigments present in (X1) and (X2) are substantially identical, for example, if they are in both cases aluminum effect pigments but have a different coating—for example, in one case a chromation and in the other case a silicate coat, or in one case being coated and in the other case not. A further, additional condition (ii) for “substantially identical pigments” in the sense of the present invention in connection with effect pigments is that the effect pigments differ from one another in their average particle size by at most ±20%, preferably at most ±15%, more preferably at most ±10%. The average particle size is the arithmetic numerical mean of the measured average particle diameter (d_{N,50%}, number-based median) as determined by laser diffraction in accordance with ISO 13320 (date: 2009). The concept of the effect pigment per se is elucidated further and in more detail hereinafter.

The term “substantially identical pigment” in the sense of the present invention in connection with color pigments is understood to mean that the color pigment or pigments present in the coating material composition (X1) and that or those present in the coating material composition (X2), as a first condition (i), differ from one another in their chromaticity by at most ±20%, preferably at most ±15%, more preferably at most ±10%, more particularly at most ±5%. The chromaticity here denotes the

$$chromaticity CIE 1976 ( CIELAB chromaticity ) \text{:}$$

$${C}_{ab}^{*} = {[ {( {a}^{*} )}^{2} + {( {b}^{*} )}^{2} ]}^{1 / 2}$$

and is determined according to DIN EN ISO 11664-4 (date: June 2012). A further, additional condition (ii) for “substantially identical pigments” in the sense of the present invention in connection with color pigments is that the color pigments differ from one another in their average particle size by at most ±20%, preferably at most ±15%, more preferably at most ±10%. The average particle size is the arithmetic numerical mean of the measured average particle diameter (d_{N,50%}) as determined by laser diffraction in accordance with ISO 13320 (date: 2009). The concept of the color pigment per se is elucidated further and in more detail hereinafter.

The method of the invention, in the event that according to step (6B) a selection is made of the coating material composition (X1) for application to a substrate, preferably includes at least the additional steps (6C), (6D), and (6E), namely

(6C) application of the coating material composition (X1) to a substrate, to form a film on the substrate, and baking of this film, to form a coating on the substrate,

(6D) investigation and assessment of the coating obtained after step (6C), with respect to the incidence or nonincidence of surface defects and/or optical defects, and

(6E) incorporation of the results obtained after implementation of step (6D) into an electronic database, preferably into the database obtainable by means of the method of the invention for compiling and/or updating an electronic database.

If the verification on the basis of the comparison as per step (4B) in step (5B) reveals that there are no stored data in the database concerning a coating material composition (X2) having a pigment content identical to or differing by not more than ±10% by weight from that of the coating material composition (X1), based on the amount of pigment present in the coating material composition (X1), and which does not contain the identical pigment or pigments or the substantially identical pigment or pigments to the coating material composition (X1), then preferably a selection as per step (6B) is made nonetheless. On further implementation of aforesaid steps (6C), (6D), and (6E), it is advantageously possible in this way for the database obtainable by means of the method of the invention for compiling and/or updating an electronic database to be further updated.

The method of the invention for screening coating material compositions when developing paint formulations, within step (4B) and/or (5B), preferably accesses a database compiled and/or updated by means of the aforesaid method of the invention for compiling and/or updating an electronic database, that has been compiled and/or updated by implementation not only of steps (1) to (3), (4A), and (5A) but also at least the further steps (3A), (3B), and (3C), with step (5A) having included the repetition of these steps (3A), (3B), and (3C). In other words, the comparison as per step (4B) and/or the verification as per step (5B) is carried out preferably on the basis of an electronic database containing not only the ascertained mean filament lengths of the coating material compositions used in the method of the invention for compiling and/or updating the database, but also, moreover, the results of the investigations and assessments relating to the incidence or nonincidence of surface defects and/or optical defects of coatings produced from these coating material compositions in accordance with step (3A).

If the verification as per step (5B) based on the comparison as per step (4B), based on such a database preferably compiled and/or updated, reveals that the database includes stored data relating to a coating material composition (X2) having a pigment content identical with that of the coating material composition (X1) or differing by not more than ±10% by weight from that of the coating material composition (X1), based on the amount of pigment present in the coating material composition (X1), and which contains the identical pigment or pigments or the substantially identical pigment or pigments to the coating material composition (X1), and whose atomization has led to an ascertained mean filament length that is already lower than the ascertained mean filament length of the coating material composition (X1), then in accordance with step (6B), as implemented above, there is an adaptation of at least one parameter.

The adaptation of at least one parameter within the formula of the coating material composition (X1) as per step (6B) preferably comprises at least one adaptation selected from the group of adaptations of the following parameters:

(i) raising or lowering the amount of at least one polymer present as binder component (a) in the coating material composition (X1),

(ii) at least partially replacing at least one polymer present as binder component (a) in the coating material composition (X1) by at least one polymer different thereto,

(iii) raising or lowering the amount of at least one pigment and/or filler present as component (b) in the coating material composition (X1), this being possible, for pigments present therein, only within the above-stated boundaries,

(iv) at least partially replacing at least one filler present as component (b) in the coating material composition (X1) by at least one filler different thereto,

(v) raising or lowering the amount of at least one organic solvent present as component (c) in the coating material composition (X1), and/or of water present therein,

(vi) at least partially replacing at least one organic solvent present as component (c) in the coating material composition (X1) by at least one organic solvent different thereto,

(vii) raising or lowering the amount of at least one additive present as component (d) in the coating material composition (X1),

(viii) at least partially replacing at least one additive present as component (d) in the coating material composition (X1) by at least one additive different thereto, and/or adding at least one further additive different thereto,

(ix) changing the sequence of the components used for preparing the coating material composition (X1), and/or

(x) raising or lowering the energy input of the mixing when preparing the coating material composition (X1).

By means of parameter (v) it is possible in particular to raise or lower the spray viscosity of the coating material composition (X1). Parameters (vii) and/or (viii) comprise in particular the replacement and/or the addition of thickeners as additives, or the changing of their amount in (X1). Such thickeners are described in more detail below in the context of component (d). Parameters (i) and/or (ii) comprise in particular the replacement and/or the addition of binders, or the changing of their amount in (X1). The concept of the binder is elucidated in more detail hereinafter. It also embraces crosslinkers (crosslinking agents). Accordingly, the parameters (i) and/or (ii) also comprise a change in the relative weight ratio of crosslinker and of that binder constituent which enters into a crosslinking reaction with the crosslinker. Parameters (i) to (iv) comprise in particular the replacement and/or the addition of binders and/or pigments, or the changing of their amount in (X1). Accordingly, these parameters (i) to (iv) implicitly also embrace a change in the pigment/binder ratio within (X1).

All preferred embodiments described hereinabove in connection with the method of the invention for determining the mean filament length and with the method of the invention for compiling and/or updating an electronic database are also preferred embodiments in relation to the method for screening coating material compositions when developing paint formulations.

Employed preferably in step (1) of the method of the invention is a basecoat material, more preferably an aqueous basecoat material, as coating material composition, more particularly an aqueous basecoat material which comprises at least one pigment such as an effect pigment. The method of the invention for screening coating material compositions when developing paint formulations accordingly relates in particular to the screening of aqueous basecoat materials which comprise at least one pigment such as an effect pigment, and is therefore carried out with consideration of the influence of the type of the at least one pigment contained therein, such as an effect pigment, the amount thereof, based on the total weight of the basecoat material, and/or the pigment/binder ratio in the basecoat material.

By means of the method of the invention it is possible in particular, on the basis of the ascertained mean filament lengths, to achieve an investigation of and more particularly an improvement in certain desired properties of coatings to be produced by means of the rotational atomization, particularly with regard to the prevention of or at least a reduction in the tendency for formation and/or incidence of optical defects and/or surface defects. This includes in particular a reduction in pinholes or an increase in pinholing robustness, an improvement in leveling, and reduction/prevention of cloudiness.

The method of the invention comprises at least the steps (1) to (3), (4B), (5B), and (6B), and also optionally (7B), but may optionally include further steps as well. Steps (1) to (3), (4B), (5B), and (6B) are preferably carried out in numerical order. Preferably, however, the method contains no step which envisions curing and/or baking of the coating material composition (X1) employed.

### Coating Material Compositions Used in the Methods of the Invention

The embodiments below pertain not only to the method of the invention for determining the mean filament length but also to the method of the invention for compiling an electronic database and to the method of the invention for screening coating material compositions when developing paint formulations. The embodiments that are described below pertain in particular to the aforesaid coating material compositions (X1), (X2), (i), and (ii) that are used.

The coating material composition used in accordance with the invention preferably comprises
at least one polymer employable as binder, as component (a),
at least one pigment and/or at least one filler as component (b), and
water and/or at least one organic solvent as component (c).

The term “comprising” or “embracing” in the sense of the present invention, especially in connection with the coating material composition used in accordance with the invention, preferably has the meaning of “consisting of”. With regard to the coating material composition used in accordance with the invention, for example, it may comprise not only components (a), (b), and (c) but also one or more of the other, optional components identified hereinafter. All these components may each be present in their preferred embodiments as stated below.

The coating material composition used in accordance with the invention is preferably a coating material composition which is employable in the automobile industry. Here it is possible to use coating material compositions which can be employed as part of an OEM paint system, and those which can be employed as part of a refinish system. Examples of coating material compositions employable in the automobile industry are electrocoat materials, primers, surfacers, basecoat materials, especially waterborne basecoat materials (aqueous basecoat materials), topcoat materials, including clearcoat materials, especially solventborne clearcoat materials. The use of waterborne basecoat materials is particularly preferred.

The concept of the basecoat material is known to the skilled person and defined for example in Römpp Lexikon, Lacke and Druckfarben, Georg Thieme Verlag, 1998, 10^{th} edition, page 57. A basecoat material, accordingly, is more particularly an interim coating material which imparts color and/or imparts color and an optical effect, used in automotive finishing and general industry coating. It is applied in general to a surfacer- or primer-pretreated metal or plastics substrate, or occasionally directly to the plastics substrate. Other possible substrates include existing finishes, possibly further requiring pretreatment (by sanding, for example). It is now entirely customary for more than one basecoat to be applied. In such a case, accordingly, a first basecoat represents the substrate for a second basecoat. To protect a basecoat, particularly from environmental effects, at least one additional clearcoat is applied over it. A waterborne basecoat material is an aqueous basecoat material in which the fraction of water is >the fraction of organic solvents, based on the total weight of water and organic solvents in % by weight within the waterborne basecoat material.

The fractions in % by weight of all components present in the coating material composition used in accordance with the invention, such as components (a), (b), and (c), and optionally one or more of the further, optional components identified hereinafter, add up to 100% by weight, based on the total weight of the coating material composition.

The solids content of the coating material composition used in accordance with the invention is preferably in a range from 10 to 45% by weight, more preferably from 11 to 42.5% by weight, very preferably from 12 to 40% by weight, more particularly from 13 to 37.5% by weight, based in each case on the total weight of the coating material composition. The solids content, i.e., the nonvolatile fraction, is determined as per the method described hereinafter.

### Component (a)

The term “binder” refers in the sense of the present invention and in agreement with DIN EN ISO 4618 (German version, date: March 2007) preferably to the nonvolatile fractions—those responsible for forming the film—of a composition such as the coating material composition employed in accordance with the invention, with the exception of the pigments and/or fillers it contains. The nonvolatile fraction may be determined according to the method described hereinafter. A binder constituent, accordingly, is any component which contributes to the binder content of a composition such as the coating material composition used in accordance with the invention. An example would be a basecoat material, such as an aqueous basecoat material, which comprises at least one polymer employable as binder as component (a), such as, for example, a below-described SCS polymer; a crosslinking agent such as a melamine resin; and/or a polymeric additive.

Particularly preferred for use as component (a) is what is called a seed-core-shell polymer (SCS polymer). Such polymers, and aqueous dispersions comprising such polymers, are known from WO 2016/116299 A1, for example. The polymer is preferably a (meth)acrylic copolymer. The polymer is used preferably in the form of an aqueous dispersion. Especially preferred for use as component (a) is a polymer having an average particle size in the range from 100 to 500 nm, preparable by successive radical emulsion polymerization of three monomer mixtures (A), (B), and (C), preferably different from one another, of olefinically unsaturated monomers in water, where

the mixture (A) comprises at least 50% by weight of monomers having a solubility in water of less than 0.5 g/l at 25° C., and a polymer prepared from the mixture (A) possesses a glass transition temperature of 10 to 65° C.,

the mixture (B) comprises at least one polyunsaturated monomer, and a polymer prepared from

the mixture (B) possesses a glass transition temperature of −35 to 15° C., and

a polymer prepared from the mixture (C) possesses a glass transition temperature of −50 to 15° C.,

and wherein

i. first the mixture (A) is polymerized,

ii. then the mixture (B) is polymerized in the presence of the polymer prepared under i., and

iii. thereafter the mixture (C) is polymerized in the presence of the polymer prepared under ii.

The preparation of the polymer comprises the successive radical emulsion polymerization of three mixtures (A), (B), and (C) of olefinically unsaturated monomers in each case in water. It is therefore a multistage radical emulsion polymerization where i. first the mixture (A) is polymerized, then ii. the mixture (B) is polymerized in the presence of the polymer prepared under i. and, furthermore, iii. the mixture (C) is polymerized in the presence of the polymer prepared under ii. All three monomer mixtures are therefore polymerized by a radical emulsion polymerization (i.e. stage or else polymerization stage), carried out separately in each case, with these stages taking place successively. In terms of time, the stages may take place immediately after one another. It is equally possible, after the end of one stage, for the reaction solution in question to be stored for a certain period and/or transferred to a different reaction vessel, and only then for the next stage to be carried out. The preparation of the polymer preferably comprises no polymerization steps other than the polymerization of the monomer mixtures (A), (B), and (C).

The mixtures (A), (B), and (C) are mixtures of olefinically unsaturated monomers. Suitable olefinically unsaturated monomers may be mono- or polyolefinically unsaturated. Examples of suitable monoolefinically unsaturated monomers include, in particular, (meth)acrylate-based monoolefinically unsaturated monomers, monoolefinically unsaturated monomers containing allyl groups, and other monoolefinically unsaturated monomers containing vinyl groups, such as vinylaromatic monomers, for example. The term (meth)acrylic or (meth)acrylate for the purposes of the present invention encompasses both methacrylates and acrylates. Preferred for use at any rate, though not necessarily exclusively, are (meth)acrylate-based monoolefinically unsaturated monomers.

The mixture (A) comprises at least 50% by weight, and preferably at least 55% by weight, of olefinically unsaturated monomers having a water solubility of less than 0.5 g/l at 25° C. One such preferred monomer is styrene. The solubility of the monomers in water is determined by means of the method described hereinafter. The monomer mixture (A) preferably contains no hydroxy-functional monomers. Likewise preferably, the monomer mixture (A) contains no acid-functional monomers. Very preferably the monomer mixture (A) contains no monomers at all that have functional groups containing heteroatoms. This means that heteroatoms, if present, are present only in the form of bridging groups. This is the case, for example, in the (meth)acrylate-based monoolefinically unsaturated monomers described above that possess an alkyl radical as radical R. The monomer mixture (A) preferably comprises exclusively monoolefinically unsaturated monomers. The monomer mixture (A) preferably comprises at least one monounsaturated ester of (meth)acrylic acid with an alkyl radical, and at least one monoolefinically unsaturated monomer containing vinyl groups and having, disposed on the vinyl group, a radical which is aromatic or that is mixed saturated aliphatic-aromatic, in which case the aliphatic fractions of the radical are alkyl groups. The monomers present in the mixture (A) are selected such that a polymer prepared from them possesses a glass transition temperature of 10 to 65° C., preferably of 30 to 50° C. The glass transition temperature here can be determined by means of the method described hereinafter. The polymer prepared in stage i. by the emulsion polymerization of the monomer mixture (A) is also called seed. The seed possesses preferably an average particle size of 20 to 125 nm (measured by dynamic light scattering as described hereinafter; cf. determination methods).

The mixture (B) comprises at least one polyolefinically unsaturated monomer, preferably at least one diolefinically unsaturated monomer. A corresponding preferred monomer is hexanediol diacrylate. The monomer mixture (B) preferably contains no hydroxy-functional monomers. Likewise preferably, the monomer mixture (B) contains no acid-functional monomers. Very preferably, the monomer mixture (B) contains no monomers at all that have functional groups containing heteroatoms. This means that heteroatoms, if present, are present only in the form of bridging groups. This is the case, for example, in the above-described (meth)acrylate-based, monoolefinically unsaturated monomers possessing an alkyl radical as radical R. Besides the at least one polyolefinically unsaturated monomer, the monomer mixture (B) preferably at any rate includes the following monomers: firstly, at least one monounsaturated ester of (meth)acrylic acid with an alkyl radical, and secondly at least one monoolefinically unsaturated monomer containing vinyl groups and having, arranged on the vinyl group, a radical which is aromatic or which is mixed saturated aliphatic-aromatic, in which case the aliphatic fractions of the radical are alkyl groups. The proportion of polyunsaturated monomers is preferably from 0.05 to 3 mol %, based on the total molar amount of monomers in the monomer mixture (B). The monomers present in the mixture (B) are selected such that a polymer prepared therefrom possesses a glass transition temperature of −35 to 15° C., preferably from −25 to +7° C. The glass transition temperature here may be determined by the method described hereinafter. The polymer prepared in the presence of the seed in stage ii. by the emulsion polymerization of the monomer mixture (B) is also referred to as the core. After stage ii., therefore, the resultant polymer comprises seed and core. The polymer which is obtained after stage ii. preferably possesses an average particle size of 80 to 280 nm, preferably 120 to 250 nm (measured by dynamic light scattering as described hereinafter; cf. determination methods).

The monomers present in the mixture (C) are selected such that a polymer prepared therefrom possesses a glass transition temperature of −50 to 15° C., preferably of −20 to +12° C. This glass transition temperature may be determined by the method described hereinafter. The olefinically unsaturated monomers of the mixture (C) are preferably selected such that the resultant polymer, comprising seed, core, and shell, has an acid number of 10 to 25. Accordingly, the mixture (C) preferably comprises at least one alpha-beta unsaturated carboxylic acid, especially preferably (meth)acrylic acid. The olefinically unsaturated monomers in the mixture (C) are preferably selected, additionally or alternatively, in such a way that the resulting polymer, comprising seed, core, and shell, has an OH number of 0 to 30, preferably 10 to 25. All of the aforementioned acid numbers and OH numbers are values calculated on the basis of the entirety of monomer mixtures employed. The monomer mixture (C) preferably comprises at least one alpha-beta unsaturated carboxylic acid and at least one monounsaturated ester of (meth)acrylic acid with an alkyl radical substituted by a hydroxyl group. With particular preference the monomer mixture (C) comprises at least one alpha-beta unsaturated carboxylic acid, at least one monounsaturated ester of (meth)acrylic acid having an alkyl radical substituted by a hydroxyl group, and at least one monounsaturated ester of (meth)acrylic acid with an alkyl radical. Where the present invention refers to an alkyl radical without further particularization, the reference is always to a pure alkyl radical without functional groups and heteroatoms. The polymer prepared in stage iii. by the emulsion polymerization of the monomer mixture (C) in the presence of seed and core is also referred to as the shell. The result after stage iii., therefore, is a polymer which comprises seed, core, and shell, in other words polymer (b). After its preparation, the polymer (b) possesses an average particle size of 100 to 500 nm, preferably 125 to 400 nm, very preferably of 130 to 300 nm (measured by dynamic light scattering as described hereinafter; cf. determination methods).

The coating material composition used in accordance with the invention preferably comprises a fraction of component (a) such as at least one SCS polymer in a range from 1.0 to 20% by weight, more preferably from 1.5 to 19% by weight, very preferably from 2.0 to 18.0% by weight, more particularly from 2.5 to 17.5% by weight, most preferably from 3.0 to 15.0% by weight, based in each case on the total weight of the coating material composition. The determination and specification of the fraction of component (a) within the coating material composition may be made via the determination of the solids content (also called nonvolatile fraction, solids content, or solids fraction) of an aqueous dispersion comprising component (a).

Additionally or alternatively, preferably additionally, to the at least one above-described SCS polymer as component (a), the coating material composition used in accordance with the invention may comprise at least one polymer different from the SCS polymer, as binder of component (a), more particularly at least one polymer selected from the group consisting of polyurethanes, polyureas, polyesters, poly(meth)acrylates and/or copolymers of the stated polymers, more particularly polyurethane-poly(meth)acrylates and/or polyurethane-polyureas.

Preferred polyurethanes are described for example in German patent application DE 199 48 004 A1, page 4, line 19 to page 11, line 29 (polyurethane prepolymer B1), in European patent application EP 0 228 003 A1, page 3, line 24 to page 5, line 40, in European patent application EP 0 634 431 A1, page 3, line 38 to page 8, line 9, and in international patent application WO 92/15405, page 2, line 35 to page 10, line 32.

Preferred polyesters are described for example in DE 4009858 A1 in column 6, line 53 to column 7, line 61 and column 10, line 24 to column 13, line 3, or WO 2014/033135 A2, page 2, line 24 to page 7, line 10 and also page 28, line 13 to page 29, line 13.

Preferred polyurethane-poly(meth)acrylate copolymers ((meth)acrylated polyurethanes) and their preparation are described for example in WO 91/15528 A1, page 3, line 21 to page 20, line 33 and also in DE 4437535 A1, page 2, line 27 to page 6, line 22.

Preferred polyurethane-polyurea copolymers are polyurethane-polyurea particles, preferably those having an average particle size of 40 to 2000 nm, where the polyurethane-polyurea particles, in each case in reacted form, comprise at least one polyurethane prepolymer containing isocyanate groups and comprising anionic groups and/or groups which can be converted into anionic groups, and also at least one polyamine containing two primary amino groups and one or two secondary amino groups. Such copolymers are used preferably in the form of an aqueous dispersion. Polymers of these kinds are preparable in principle by conventional polyaddition of, for example, polyisocyanates with polyols and also polyamines. The average particle size of such polyurethane-polyurea particles is determined as described below (measured by means of dynamic light scattering as described hereinafter; cf. determination methods).

The fraction in the coating material composition of such polymers different from the SCS polymer is preferably smaller than the fraction of the SCS polymer. The polymers described are preferably hydroxy-functional and especially preferably possess an OH number in the range from 15 to 200 mg KOH/g, more preferably of 20 to 150 mg KOH/g.

With particular preference the coating material compositions used in accordance with the invention comprise at least one hydroxy-functional polyurethane-poly(meth)acrylate copolymer;

with further preference they comprise at least one hydroxy-functional polyurethane-poly(meth)acrylate copolymer and also at least one hydroxy-functional polyester and also, optionally, a preferably hydroxy-functional polyurethane-polyurea copolymer.

The fraction of the further polymers as binders of component (a)—additionally to an SCS polymer—may vary widely and is preferably in the range from 1.0 to 25.0% by weight, more preferably 3.0 to 20.0% by weight, very preferably 5.0 to 15.0% by weight, based in each case on the total weight of the coating material composition.

The coating material composition may further comprise at least one conventional, typical crosslinking agent. If it comprises a crosslinking agent, the species in question is preferably at least one amino resin and/or at least one blocked or free polyisocyanate, preferably an amino resin. Among the amino resins, melamine resins in particular are preferred. Where the coating material composition includes crosslinking agents, the fraction of these crosslinking agents, more particularly amino resins and/or blocked or free polyisocyanates, more preferably amino resins, in turn preferably melamine resins, is preferably in the range from 0.5 to 20.0% by weight, more preferably 1.0 to 15.0% by weight, very preferably 1.5 to 10.0% by weight, based in each case on the total weight of the coating material composition. The fraction of crosslinking agent is preferably smaller than the fraction of the SCS polymer in the coating material composition.

### Component (b)

A skilled person is familiar with the terms “pigments” and “fillers”.

The term “filler” is known to the skilled person from DIN 55943 (date: October 2001), for example. A “filler” in the sense of the present invention is preferably a component which is substantially, preferably completely, insoluble in the coating material composition used in accordance with the invention, such as a waterborne basecoat material, for example, and which is used in particular for the purpose of increasing the volume. “Fillers” in the sense of the present invention are preferably different from “pigments” in their refractive index, which for fillers is <1.7. Any customary filler known to the skilled person may be used as component (b). Examples of suitable fillers are kaolin, dolomite, calcite, chalk, calcium sulfate, barium sulfate, graphite, silicates such as magnesium silicates, especially corresponding phyllosilicates such as hectorite, bentonite, montmorillonite, talc and/or mica, silicas, especially fumed silicas, hydroxides such as aluminum hydroxide or magnesium hydroxide, or organic fillers such as textile fibers, cellulose fibers, polyethylene fibers or polymer powders.

The term “pigment” is likewise known to the skilled person, from DIN 55943 (date: October 2001), for example. A “pigment” in the sense of the present invention refers preferably to components in powder or platelet form which are substantially, preferably entirely, insoluble in the coating material composition used in accordance with the invention, such as a waterborne basecoat material, for example. These “pigments” are preferably colorants and/or substances which can be used as pigment by virtue of their magnetic, electrical and/or electromagnetic properties. Pigments differ from “fillers” preferably in their refractive index, which for pigments is ≥1.7.

The term “pigments” preferably subsumes color pigments and effect pigments.

A skilled person is familiar with the concept of color pigments. For the purposes of the present invention, the terms “color-imparting pigment” and “color pigment” are interchangeable. A corresponding definition of the pigments and further specifications thereof are dealt with in DIN 55943 (date: October 2001). Color pigment used may comprise organic and/or inorganic pigments. Particularly preferred color pigments used are white pigments, chromatic pigments and/or black pigments. Examples of white pigments are titanium dioxide, zinc white, zinc sulfide, and lithopones. Examples of black pigments are carbon black, iron manganese black, and spinel black. Examples of chromatic pigments are chromium oxide, chromium oxide hydrate green, cobalt green, ultramarine green, cobalt blue, ultramarine blue, manganese blue, ultramarine violet, cobalt and manganese violet, red iron oxide, cadmium sulfoselenide, molybdate red and ultramarine red, brown iron oxide, mixed brown, spinel phases and corundum phases, and chromium orange, yellow iron oxide, nickel titanium yellow, chromium titanium yellow, cadmium sulfide, cadmium zinc sulfide, chromium yellow, and bismuth vanadate.

A skilled person is familiar with the concept of effect pigments. A corresponding definition is found for example in Römpp Lexikon, Lacke and Druckfarben, Georg Thieme Verlag, 1998, 10th edition, pages 176 and 471. A definition of pigments in general and further specifications thereof are dealt with in DIN 55943 (date: October 2001). Effect pigments are preferably pigments which impart optical effect or color and optical effect, especially optical effect. The terms “optical effect-imparting and color-imparting pigment”, “optical effect pigment” and “effect pigment” are therefore preferably interchangeable. Preferred effect pigments are, for example, platelet-shaped metallic effect pigments such as leaflet-like aluminum pigments, gold bronzes, oxidized bronzes and/or iron oxide-aluminum pigments, pearlescent pigments such as pearl essence, basic lead carbonate, bismuth oxychloride and/or metal oxide-mica pigments and/or other effect pigments such as leaflet-like graphite, leaflet-like iron oxide, multilayer effect pigments from PVD films and/or liquid crystal polymer pigments. Particularly preferred are effect pigments in leaflet form, especially leaflet-like aluminum pigments and metal oxide-mica pigments.

The coating material composition used in accordance with the invention, such as a waterborne basecoat material, for example, with particular preference includes at least one effect pigment as component (b).

The coating material composition used in accordance with the invention preferably comprises a fraction of effect pigment as component (b) in a range from 1 to 20% by weight, more preferably from 1.5 to 18% by weight, very preferably from 2 to 16% by weight, more particularly from 2.5 to 15% by weight, most preferably from 3 to 12% by weight or from 3 to 10% by weight, based in each case on the total weight of the coating material composition. The total fraction of all pigments and/or fillers in the coating material composition is preferably in the range from 0.5 to 40.0% by weight, more preferably from 2.0 to 20.0% by weight, very preferably from 3.0 to 15.0% by weight, based in each case on the total weight of the coating material composition.

The relative weight ratio of component (b) such as at least one effect pigment to component (a) such as at least one SCS polymer in the coating material composition is preferably within a range from 4:1 to 1:4, more preferably in a range from 2:1 to 1:4, very preferably in a range from 2:1 to 1:3, more particularly in a range from 1:1 to 1:3 or from 1:1 to 1:2.5.

### Component (c)

The coating material composition used in accordance with the invention is preferably aqueous. It is preferably a system comprising as its solvent (i.e., as component (c)) primarily water, preferably in an amount of at least 20% by weight, and organic solvents in smaller fractions, preferably in an amount of <20% by weight, based in each case on the total weight of the coating material composition.

The coating material composition used in accordance with the invention preferably comprises a fraction of water of at least 20% by weight, more preferably of at least 25% by weight, very preferably of at least 30% by weight, more particularly of at least 35% by weight, based in each case on the total weight of the coating material composition.

The coating material composition used in accordance with the invention preferably comprises a fraction of water that is within a range from 20 to 65% by weight, more preferably in a range from 25 to 60% by weight, very preferably in a range from 30 to 55% by weight, based in each case on the total weight of the coating material composition.

The coating material composition used in accordance with the invention preferably comprises a fraction of organic solvents that is within a range of <20% by weight, more preferably in a range from 0 to <20% by weight, very preferably in a range from 0.5 to <20% by weight or to 15% by weight, based in each case on the total weight of the coating material composition.

Examples of such organic solvents include heterocyclic, aliphatic or aromatic hydrocarbons, mono- or polyhydric alcohols, especially methanol and/or ethanol, ethers, esters, ketones, and amides, such as N-methylpyrrolidone, N-ethylpyrrolidone, dimethylformamide, toluene, xylene, butanol, ethyl glycol and butyl glycol and also their acetates, butyl diglycol, diethylene glycol dimethyl ether, cyclohexanone, methyl ethyl ketone, methyl isobutyl ketone, acetone, isophorone, or mixtures thereof.

### Further Optional Components

The coating material composition used in accordance with the invention may optionally further comprise at least one thickener (also referred to as thickening agent) as component (d). Examples of such thickeners are inorganic thickeners, as for example metal silicates such as phyllosilicates, and organic thickeners, as for example poly(meth)acrylic acid thickeners and/or (meth)acrylic acid-(meth)acrylate copolymer thickeners, polyurethane thickeners, and also polymeric waxes. The metal silicate is selected preferably from the group of the smectites. The smectites are selected with particular preference from the group of the montmorillonites and hectorites. The montmorillonites and hectorites are selected more particularly from the group consisting of aluminum magnesium silicates and also sodium magnesium phyllosilicates and sodium magnesium fluorine lithium phyllosilicates. These inorganic phyllosilicates are sold under the brand name Laponite®, for example. Thickening agents based on poly(meth)acrylic acid and (meth)acrylic acid-(meth)acrylate copolymer thickeners are optionally crosslinked and/or neutralized with a suitable base. Examples of such thickening agents are “alkali swellable emulsions” (ASEs) and hydrophobically modified variants of them, the “hydrophobically modified alkali swellable emulsions” (HASE). These thickening agents are preferably anionic. Corresponding products such as Rheovis® AS 1130 are available commercially. Thickening agents based on polyurethanes (e.g., polyurethane associative thickening agents) are optionally crosslinked and/or neutralized with a suitable base. Corresponding products such as Rheovis® PU1250 are available commercially. Examples of suitable polymeric waxes include optionally modified polymeric waxes based on ethylene-vinyl acetate copolymers. A corresponding product is available commercially under the designation Aquatix® 8421, for example.

Depending on the desired application, the coating material composition used in accordance with the invention may comprise one or more commonly employed additives as further component or components (d). By way of example, the coating material composition may comprise at least one additive selected from the group consisting of reactive diluents, light stabilizers, antioxidants, deaerating agents, emulsifiers, slip additives, polymerization inhibitors, initiators for radical polymerizations, adhesion promoters, flow control agents, film-forming assistants, sag control agents (SCAs), flame retardants, corrosion inhibitors, siccatives, biocides, and flatting agents. They may be used in the known and customary proportions.

The coating material composition used in accordance with the invention may be produced using the customary and known mixing methods and mixing units.

### Determination Methods

### 1. Determination of Nonvolatile Fraction

The nonvolatile fraction (the solids content) is determined according to DIN EN ISO 3251 (date: June 2008). 1 g of sample is weighed out into an aluminum dish which has been dried beforehand and the dish with sample is dried in a drying cabinet at 125° C. for 60 minutes, cooled in a desiccator, and then reweighed. The residue relative to the total amount of sample used corresponds to the nonvolatile fraction. The volume of the nonvolatile fraction may be determined if necessary, in accordance with DIN 53219 (date: August 2009) optionally.

### 2. Determination of Number-Average Molecular Weight

The number-average molecular weight (Mₙ) is determined, unless otherwise specified, using a model 10.00 vapor pressure osmometer (from Knauer) on concentration series in toluene at 50° C. with benzophenone as a calibration substance for determining the experimental calibration constant of the instrument used, in accordance with E. Schröder, G. Müller, K.-F. Arndt, “Leitfaden der Polymercharakterisierung” [Principles of polymer characterization], Akademie-Verlag, Berlin, pp. 47-54, 1982.

### 3. Determination of OH Number and of Acid Number

The OH number and the acid number are each determined by calculation.

### 4. Determination of Average Particle Size of SCS Polymers and Polyurethane-Polyurea Particles

The average particle size is determined by dynamic light scattering (photon correlation spectroscopy) (PCS) in a method based on DIN ISO 13321 (date: October 2004). Measurement takes place using a Malvern Nano S90 (from Malvern Instruments) at 25±1° C. The instrument covers a size range from 3 to 3000 nm and is equipped with a 4 mW He—Ne laser at 633 nm. The respective samples are diluted with particle-free deionized water as dispersing medium and then measured in a 1 ml polystyrene cuvette at suitable scattering intensity. Evaluation took place using a digital correlator with assistance from the Zetasizer evaluation software 7.11 (from Malvern Instruments). Measurement is carried out five times and the measurements are repeated on a second, freshly prepared sample. For the SCS polymer, the average particle size refers to the arithmetic numerical mean of the measured average particle diameter (Z-average mean; numerical average; d_{N,50%}). The standard deviation of a 5-fold determination in this case is ≤4%. For the polyurethane-polyurea particles that can be employed, the average particle size refers to the arithmetic volume mean of the average particle size of the individual preparations (V-average mean; volume average; d_{V,50%} (volume-based median)). The maximum deviation of the volume average from five individual measurements in this case is ±15%. Verification takes place with polystyrene standards each having certified particle sizes between 50 to 3000 nm.

### 5. Determination of Film Thicknesses

The film thicknesses are determined in accordance with DIN EN ISO 2808 (date: May 2007), method 12A, using the MiniTest® 3100-4100 instrument from ElektroPhysik.

### 6. Assessment of the Incidence of Pinholes and the Film Thickness-Dependent Leveling

To assess the incidence of pinholes and the film thickness-dependent leveling, wedge-format multicoat paint systems are produced in accordance with the following general protocol:

A steel panel with dimensions of 30×50 cm, coated with a standard electrocoat (CathoGuard® 800 from BASF Coatings GmbH), is provided at one longitudinal edge with an adhesive strip (Tesaband, 19 mm) to allow determination of film thickness differences after coating. A waterborne basecoat material is applied electrostatically as a wedge with a target film thickness (film thickness of the dried material) of 0-40 μm. The discharge rate here is between 300 and 400 ml/min; the rotary speed of the ESTA bell is varied between 23 000 and 43 000 rpm; the exact figures for each of the application parameters specifically selected are stated below within the experimental section. After a flash-off time of 4-5 minutes at room temperature (18 to 23° C.), the system is dried in a forced air oven at 60° C. for 10 minutes. Following removal of the adhesive strip, a commercial two-component clearcoat material (ProGloss® from BASF Coatings GmbH) is applied by gravity-fed spray gun, manually, to the dried waterborne basecoat, with a target film thickness (film thickness of the dried material) of 40-45 μm. The resulting clearcoat is flashed off at room temperature (18 to 23° C.) for 10 minutes; this is followed by curing in a forced air oven at 140° C. for a further 20 minutes.

Incidence of pinholes is assessed visually according to the following general protocol: the dry film thickness of the waterborne basecoat material is checked, and, for the basecoat film thickness wedge, the ranges of 0-20 μm and also of 20 μm to the end of the wedge are marked on the steel panel. The pinholes are evaluated visually in the two separate regions of the waterborne basecoat wedge. The number of pinholes per region is counted. All results are standardized to an area of 200 cm² and then summed to give a total number. Additionally, where appropriate, a record is made of the dry film thickness of the waterborne basecoat wedge from which pinholes no longer occur.

The film thickness-dependent leveling is assessed according to the following general protocol: the dry film thickness of the waterborne basecoat material is checked, and, for the basecoat film thickness wedge, different regions, for example 10-15 μm, 15-20 μm, and 20-25 μm, are marked on the steel panel. The film thickness-dependent leveling is determined and assessed using the Wave scan instrument from Byk-Gardner GmbH, within the basecoat film thickness regions ascertained beforehand. For this purpose, a laser beam is directed at an angle of 60° onto the surface under investigation, and fluctuations in the reflected light in the short wave range (0.3 to 1.2 mm) and in the long wave range (1.2 to 12 mm) are recorded by the instrument over a distance of 10 cm (long wave=LW; short wave=SW; the lower the figures, the better the appearance). Furthermore, as a measure of the sharpness of an image reflected in the surface of the multicoat system, the characteristic parameter of “distinctness of image” (DOI) is determined with the aid of the instrument (the higher the value, the better the appearance).

### 7. Determination of Cloudiness

For determining the cloudiness, multicoat paint systems are produced according to the following general protocol:

A steel panel with dimensions 32×60 cm, coated with a conventional surfacer system, is further coated with a waterborne basecoat material by means of dual application: application in the first step is made electrostatically with a target film thickness of 8-9 μm, and in the second step, after a 2-minute flash-off time at room temperature, it is made likewise electrostatically with a target film thickness of 4-5 μm. After a further flash-off time at room temperature (18 to 23° C.) of 5 minutes, the resulting waterborne basecoat is dried in a forced air oven at 80° C. for 5 minutes. Both basecoat applications are made with a rotary speed of 43 000 rpm and a discharge rate of 300 ml/min. Applied atop the dried waterborne basecoat is a commercial two-component clearcoat material (ProGloss from BASF Coatings GmbH), with a target film thickness of 40-45 μm. The resulting clearcoat is flashed off at room temperature (18 to 23° C.) for 10 minutes; this is followed by curing in a forced air oven at 140° C. for a further 20 minutes.

The cloudiness is then assessed using the cloud-runner instrument from BYK-Gardner GmbH. The instrument outputs parameters including the three characteristic parameters of “mottling15”, “mottling45”, and “mottling60”, which can be seen as a measure of the cloudiness measured at the angles of 15°, 45°, and 60° relative to the reflection angle of the measurement light source used. The higher the value, the more pronounced the cloudiness.

### 8. Determination of Thread Lifetime in an Extension Experiment

The high-speed rotational atomization produces flows which have a high extensional component. In order to investigate the extension behavior of the samples used, the Haake CaBER 1 instrument (from Thermo Scientific) is utilized. The sample in this case is located between two parallel plates which have a diameter of 6 mm and a distance of 2 mm from one another. The upper plate is subsequently displaced within 40 ms upward such that the new distance between the two plates is 10 mm. This produces an unstable thread of liquid with a diameter which tapers due to capillary forces. The thread diameter (i.e., the filament diameter) is recorded by means of a high-speed camera at an image rate of 1000 images per second and at a resolution of 1024×1024 pixels. Extensional-rheology properties of the material are determined from the evolution of the thread diameter. Here, materials having a relatively high resistance to extensional flows (that is, a greater extensional viscosity) are those which exhibit a relatively long thread lifetime (filament lifetime).

### 9. Determination of the Mean Filament Length by the Method of the Invention for Determining the Mean Filament Length

The breakdown of the filaments at the bell edge is recorded by means of the high-speed camera Fastcam SA-Z (from Photron Tokyo, Japan) at an image rate of 100 000 images per second and at a resolution of 512×256 pixels. Image analysis uses 2000 images per recording. First of all, the individual images are processed in a number of steps in order to be able to evaluate the length of the filaments. In the first process step, the bell edge is removed from the respective images. For this purpose, each image is smoothed by means of a Gaussian filter to an extent such that only the bell edge is still visible. These images are subsequently binarized and inverted (a). After that, the original images as well are binarized (b) and are added together with the inverted images (a). The result obtained is a binarized series of images without bell edge, and this series of images is inverted (c) for further evaluation. In the next step, conditions are defined so that filaments can be distinguished from other objects. First, the hypotenuses of all the objects are determined, being calculated by means of xₘᵢₙ, xₘₐₓ, yₘᵢₙ, and yₘₐₓ of the objects. The hypotenuses of the objects must be greater than a defined value h for the object thereof to be regarded as a filament. All smaller objects, such as drops, are no longer considered for the subsequent evaluation. Moreover, each object must have a y value which is located in the immediate vicinity of the bell edge. Accordingly, longer fragments, which are not joined to the bell edge, are excluded for the purposes of evaluating the filament length. Lastly, the remaining objects are required to meet the condition that their minimum x value is greater than 0 and their maximum x value is smaller than 256. Accordingly, the only filaments evaluated are those which are located entirely within the recorded image frame. All objects which are able to meet the four conditions are called up individually and tapered using the skeleton method. As a result, only one pixel of each object is connected at most to one other pixel. Subsequently, the number of pixels per filament is counted up. Because the pixel size is known, the actual length of the filaments can be calculated. This image analysis evaluates approximately 15 000 filaments per picture. This ensures a high statistical base for the determination of the filament lengths.

10. Determining the Solubility of the Monomers of the Mixture (A) in Water that can be Used for Preparing SCS Polymers

The solubility of the monomers in water is determined via establishment of equilibrium with the gas space above the aqueous phase (in analogy to the reference X.-S. Chai, Q. X. Hou, F. J. Schork, Journal of Applied Polymer Science vol. 99, 1296-1301 (2006)). For this purpose, in a 20 ml gas space sample tube, a defined volume of water, such as 2 ml, is admixed with the respective monomer in a mass so great that it is unable to dissolve, or at any rate to dissolve completely, in the volume of water selected. Additionally an emulsifier (10 ppm, based on total mass of the sample mixture) is added. To obtain the equilibrium concentration, the mixture is shaken continually. The supernatant gas phase is replaced by inert gas, thus re-establishing an equilibrium. In the gas phase removed, the fraction of the substance to be detected is measured in each case (by means of gas chromatography, for example). The equilibrium concentration in water can be determined by plotting the fraction of the monomer in the gas phase as a graph. The slope of the curve changes from a virtually constant value (S1) to a significantly negative slope (S2) as soon as the excess monomer fraction has been removed from the mixture. The equilibrium concentration here is reached at the point of intersection of the straight line with the slope 51 and of the straight line with the slope S2. The determination described is carried out at 25° C.

11. Determination of Glass Transition Temperatures of Polymers Obtainable from Monomers of Mixtures (A), (B), and (C), Respectively

The glass transition temperature T_{g} is determined experimentally in a method based on DIN 51005 (date: August 2005) “Thermal Analysis (TA)—terms” and DIN 53765 “Thermal Analysis—Dynamic Scanning calorimetry (DSC)” (date: March 1994). This involves weighing out a 15 mg sample into a sample boat and introducing the boat into a DSC instrument. Cooling takes place to the starting temperature, after which 1^{st} and 2^{nd} measurement runs are carried out under inert gas purging (N₂) of 50 ml/min at a heating rate of 10 K/min, with cooling back to the starting temperature between the measurement runs. Measurement takes place in the temperature range from approximately 50° C. lower than the expected glass transition temperature to approximately 50° C. higher than the expected glass transition temperature. The glass transition temperature recorded, in accordance with DIN 53765, section 8.1, is the temperature in the 2^{nd} measurement run at which half of the change in specific heat capacity (0.5 delta cp) has been reached. It is determined from the DSC diagram (plot of heat flow against temperature). It is the temperature corresponding to the point of intersection of the midline between the extrapolated baselines before and after the glass transition with the measurement plot. For a useful estimation of the glass transition temperature to be expected in the measurement, the known Fox equation can be employed. Since the Fox equation represents a good approximation, based on the glass transition temperatures of the homopolymers and their parts by weight without including the molecular weight, it may be used as a useful tool for the skilled person at the synthesis stage, allowing a desired glass transition temperature to be set via a few goal-directed trials.

### 12. Determination of Wetness

An assessment is made of the wetness of a film formed after application to a substrate of a coating material composition such as a waterborne basecoat material. The coating material composition in this case is applied electrostatically by means of rotational atomization as a constant layer in the desired target film thickness (film thickness of the dried material) such as a target film thickness within a range from 15 μm to 40 μm. The discharge rate is between 300 and 400 ml/min and the rotary speed of the ESTA bell of the rotary atomizer is in a range from 23 000 to 63 000 rpm (the precise details of the application parameters specifically selected in each case are stated at the relevant points hereinafter within the experimental section). A visual assessment of the wetness of the film formed on the substrate is made one minute after the end of application. The wetness is recorded on a scale from 1 to 5 (1=very dry to 5=very wet).

### 13. Determination of the Incidence of Pops

To determine the propensity toward popping, a multicoat paint system is produced in a method based on DIN EN ISO 28199-1 (date: January 2010) and DIN EN ISO 28199-3 (date: January 2010) in accordance with the following general protocol: a perforated steel plate with dimensions of 57 cm×20 cm (according to DIN EN ISO 28199-1, section 8.1, version A), coated with a cured cathodic electrocoat (EC) (CathoGuard® 800 from BASF Coatings GmbH), is prepared in analogy to DIN EN ISO 28199-1, section 8.2 (version A). This is followed, in a method based on DIN EN ISO 28199-1, section 8.3, by electrostatic application of an aqueous basecoat material in a single application in the form of a wedge with a target film thickness (film thickness of the dried material; dry film thickness) in the range from 0 μm to 30 μm. The resulting basecoat, without a flash-off time beforehand, is subjected to interim drying in a forced air oven at 80° C. for 5 minutes. The determination of the popping limit, i.e., of the basecoat film thickness from which pops occur, is made according to DIN EN ISO 28199-3, section 5.

### 14. Determination of the Incidence of Runs

To determine the propensity toward running, multicoat paint systems are produced in a method based on DIN EN ISO 28199-1 (date: January 2010) and DIN EN ISO 28199-3 (date: January 2010) in accordance with the following general protocol:

a) Waterborne Basecoat Materials
a perforated steel plate with dimensions of 57 cm×20 cm (according to DIN EN ISO 28199-1, section 8.1, version A), coated with a cured cathodic electrocoat (EC) (CathoGuard® 800 from BASF Coatings GmbH), is prepared in analogy to DIN EN ISO 28199-1, section 8.2 (version A). This is followed, in a method based on DIN EN ISO 28199-1, section 8.3, by electrostatic application of an aqueous basecoat material in a single application in the form of a wedge with a target film thickness (film thickness of the dried material) in the range from 0 μm to 40 μm. The resulting basecoat, after a flash-off time at 18-23° C. of 10 minutes, is subjected to interim drying in a forced air oven at 80° C. for 5 minutes. The panels here are flashed off and subjected to interim drying while standing vertically.

b) Clearcoat Materials:
A perforated steel plate with dimensions of 57 cm×20 cm (according to DIN EN ISO 28199-1, section 8.1, version A), coated with a cured cathodic electrocoat (EC) (CathoGuard® 800 from BASF Coatings GmbH) and with a commercially available waterborne basecoat material (ColorBrite from BASF Coatings GmbH), is prepared in analogy to DIN EN ISO 28199-1, section 8.2 (version A). This is followed, in a method based on DIN EN ISO 28199-1, section 8.3, by electrostatic application of a clearcoat material in a single application in the form of a wedge with a target film thickness (film thickness of the dried material) in the range from 0 μm to 60 μm. The resulting clearcoat film, after a flash-off time at 18-23° C. of 10 minutes, is cured in a forced air oven at 140° C. for 20 minutes. The panels here are flashed off and cured while standing vertically.
The propensity toward running is determined in each case in accordance with DIN EN ISO 28199-3, section 4. In addition to the film thickness at which a run exceeds the length of 10 mm from the bottom edge of the perforation, a determination is made of the film thickness from which a first propensity to run at a perforation can be observed visually.

### 15. Determination of the Hiding Power

The hiding power is determined according to DIN EN ISO 28199-3 (January 2010; section 7).

### Inventive and Comparative Examples

The inventive and comparative examples below serve to illustrate the invention, but should not be interpreted as limiting.

Unless otherwise stated, the figures in parts are parts by weight, and figures in percent are percentages by weight in each case.

### 1. Preparation of an Aqueous Dispersion AD1

1.1 The meanings of the components identified below and used in preparing the aqueous dispersion AD1 are as follows:

DMEA dimethylethanolamine

DI water deionized water

EF 800Aerosol® EF-800, commercially available emulsifier from Cytec

APS ammonium peroxodisulfate

1,6-HDDA 1,6-hexanediol diacrylate

2-HEA 2-hydroxyethyl acrylate

MMA methyl methacrylate

1.2 Preparation of the aqueous dispersion AD1 comprising a multistage SCS polyacrylate

### Monomer Mixture (A), Stage i.

80 wt % of items 1 and 2 as per table 1.1 below are placed in a steel reactor (5 l volume) with reflux condenser and are heated to 80° C. The remaining fractions of the components listed under “Initial charge” in table 1.1 are premixed in a separate vessel. This mixture and, separately therefrom, the “Initiator solution” (table 1.1, items 5 and 6) are added dropwise to the reactor simultaneously over the course of 20 minutes, a fraction of the monomers in the reaction solution, based on the total amount of monomers used in stage i., not exceeding 6.0 wt % throughout the reaction time. 30 minutes of stirring follows.

### Monomer Mixture (B), Stage ii.

The components indicated under “Mono 1” in table 1.1 are premixed in a separate vessel. This mixture is added dropwise to the reactor over the course of 2 hours, a fraction of the monomers in the reaction solution, based on the total amount of monomers used in stage ii., not exceeding 6.0 wt % throughout the reaction time. 1 hour of stirring follows.

### Monomer Mixture (C), Stage iii.

The components indicated under “Mono 2” in table 1.1 are premixed in a separate vessel. This mixture is added dropwise to the reactor over the course of 1 hour, a fraction of the monomers in the reaction solution, based on the total amount of monomers used in stage iii., not exceeding 6.0 wt % throughout the reaction time. 2 hours of stirring follows.

Thereafter the reaction mixture is cooled to 60° C. and the neutralizing mixture (table 1.1, items 20, 21, and 22) is premixed in a separate vessel. The neutralizing mixture is added dropwise to the reactor over the course of 40 minutes, the pH of the reaction solution being adjusted to a pH of 7.5 to 8.5. The reaction product is subsequently stirred for 30 minutes more, cooled to 25° C., and filtered.

The solids content of the resulting aqueous dispersion AD1 was determined for reaction monitoring. The result, together with the pH and the particle size determined, is reported in table 1.2.

TABLE 1.1
Aqueous dispersion AD1 comprising a
multistage polyacrylate

| | | AD1 |
|---|---|---|
| | Initial charge | |
| 1 | DI water | 41.81 |
| 2 | EF 800 | 0.18 |
| 3 | Styrene | 0.68 |
| 4 | n-Butyl acrylate | 0.48 |
| | Initiator solution | |
| 5 | DI water | 0.53 |
| 6 | APS | 0.02 |
| | Mono 1 | |
| 7 | DI water | 12.78 |
| 8 | EF 800 | 0.15 |
| 9 | APS | 0.02 |
| 10 | Styrene | 5.61 |
| 11 | n-Butyl acrylate | 13.6 |
| 12 | 1,6-HDDA | 0.34 |
| | Mono 2 | |
| 13 | DI water | 5.73 |
| 14 | EF 800 | 0.07 |
| 15 | APS | 0.02 |
| 16 | Methacrylic acid | 0.71 |
| 17 | 2-HEA | 0.95 |
| 18 | n-Butyl acrylate | 3.74 |
| 19 | MMA | 0.58 |
| | Neutralizing | |
| 20 | DI water | 6.48 |
| 21 | Butyl glycol | 4.76 |
| 22 | DMEA | 0.76 |

TABLE 1.2
Characteristics of the aqueous dispersion AD1
or of the polymer comprised

| | AD1 |
|---|---|
| Solids content [wt %] | 25.6 |
| pH | 8.85 |
| Particle size [nm] | 246 |

### 2. Preparation of an Aqueous Polyurethane-Polyurea Dispersion PD1

### Preparation of a Partially Neutralized Prepolymer Solution

In a reaction vessel equipped with stirrer, internal thermometer, reflux condenser and electrical heating, 559.7 parts by weight of a linear polyester polyol and 27.2 parts by weight of dimethylol propionic acid (from GEO Speciality Chemicals) were dissolved under nitrogen in 344.5 parts by weight of methyl ethyl ketone. The linear polyester diol was prepared beforehand from dimerized fatty acid (Pripol® 1012, Croda), isophthalic acid (from BP Chemicals) and hexane-1,6-diol (from BASF SE) (weight ratio of the starting materials: dimeric fatty acid to isophthalic acid to hexane-1,6-diol=54.00:30.02:15.98) and had a hydroxyl number of 73 mg KOH/g solids fraction, an acid number of 3.5 mg KOH/g solids fraction, a calculated number-average molecular weight of 1379 g/mol, and a number-average molecular weight as determined by vapor pressure osmometry of 1350 g/mol. Added to the resulting solution at 30° C. in succession were 213.2 parts by weight of dicyclohexylmethane 4,4′-diisocyanate (Desmodur® W, Covestro AG), with an isocyanate content of 32.0 wt %, and 3.8 parts by weight of dibutyltin dilaurate (from Merck). This was followed by heating to 80° C. with stirring. Stirring continued at this temperature until the isocyanate content of the solution was constant at 1.49 wt %. Thereafter 626.2 parts by weight of methyl ethyl ketone were added to the prepolymer and the reaction mixture was cooled to 40° C. When 40° C. was reached, 11.8 parts by weight of triethylamine (from BASF SE) were added dropwise over the course of two minutes, and the batch was stirred for a further five minutes.

Reaction of the Prepolymer with Diethylenetriamine Diketimine

30.2 parts by weight of a 71.9 wt % dilution of diethylenetriamine diketimine in methyl isobutyl ketone (ratio of prepolymer isocyanate groups to diethylenetriamine diketimine (having one secondary amino group): 5:1 mol/mol, corresponding to two NCO groups per blocked primary amino group) were subsequently admixed over the course of a minute, with the reaction temperature rising briefly by 1° C. following addition to the prepolymer solution. The diluted preparation of diethylenetriamine diketimine in methyl isobutyl ketone was prepared beforehand by azeotropic removal of water of reaction during the reaction of diethylenetriamine (from BASF SE) with methyl isobutyl ketone in methyl isobutyl ketone at 110-140° C. Dilution with methyl isobutyl ketone was used to set an amine equivalent mass (solution) of 124.0 g/eq. IR spectroscopy, on the basis of the residual absorption at 3310 cm⁻¹, found 98.5% blocking of the primary amino groups. The solids content of the polymer solution containing isocyanate groups was found to be 45.3%.

### Dispersing and Vacuum Distillation

After 30 minutes of stirring at 40° C., the contents of the reactor were dispersed over 7 minutes into 1206 parts by weight of deionized water (23° C.). Methyl ethyl ketone was distilled off under reduced pressure from the resulting dispersion at 45° C., and any losses of solvent and of water were made up with deionized water, to give a solids content of 40 wt %. The resulting dispersion was white, stable, high in solids content and low in viscosity, contained crosslinked particles, and showed no sedimentation at all even after three months.

The characteristics of the resulting microgel dispersion (PD1) were as follows:

Solids content (130° C., 60 min, 1 g): 40.2 wt %

Methyl ethyl ketone content (GC): 0.2 wt %

Methyl isobutyl ketone content (GC): 0.1 wt %

Viscosity (23° C., rotational viscometer,

shear rate=1000/s): 15 mPa·s

Acid number: 17.1 mg KOH/g solids content

Degree of neutralization (calculated): 49%

pH (23° C.): 7.4

Particle size (photon correlation spectroscopy, volume average): 167 nm

Gel fraction (freeze-dried): 85.1 wt %

Gel fraction (130° C.): 87.3 wt %

### 3. Preparation of Color and Filler Pastes

### 3.1 Production of a Yellow Paste P1

The yellow paste P1 is produced from 17.3 parts by weight of Sicotrans yellow L 1916, available from BASF SE, 18.3 parts by weight of a polyester prepared as per example D, column 16, lines 37-59 of DE 40 09 858 A1, 43.6 parts by weight of a binder dispersion prepared as per international patent application WO 92/15405, page 15, lines 23-28, 16.5 parts by weight of deionized water, and 4.3 parts by weight of butyl glycol.

### 3.2 Production of a White Paste P2

The white paste P2 is produced from 50 parts by weight of Titanium Rutile 2310, 6 parts by weight of a polyester prepared as per example D, column 16, lines 37-59 of DE 40 09 858 A1, 24.7 parts by weight of a binder dispersion prepared as per patent application EP 022 8003 B2, page 8, lines 6 to 18, 10.5 parts by weight of deionized water, 4 parts by weight of 2,4,7,9-tetramethyl-5-decynediol, 52% in BG (available from BASF SE), 4.1 parts by weight of butyl glycol, 0.4 part by weight of 10% dimethylethanolamine in water, and 0.3 part by weight of Acrysol RM-8 (available from The Dow Chemical Company).

### 3.3 Production of a Black Paste P3

The black paste P3 is produced from 57 parts by weight of a polyurethane dispersion prepared as per WO 92/15405, page 13, line 13 to page 15, line 13, 10 parts by weight of carbon black (Monarch® 1400 carbon black from Cabot Corporation), 5 parts by weight of a polyester prepared as per example D, column 16, lines 37-59 of DE 40 09 858 A1, 6.5 parts by weight of a 10% strength aqueous dimethylethanolamine solution, 2.5 parts by weight of a commercial polyether (Pluriol® P900, available from BASF SE), 7 parts by weight of butyl diglycol, and 12 parts by weight of deionized water.

### 3.4 Production of a Barium Sulfate Paste P4

The barium sulfate paste P4 is produced from 39 parts by weight of a polyurethane dispersion prepared as per EP 0228003 B2, page 8, lines 6 to 18, 54 parts by weight of barium sulfate (Blanc fixe micro from Sachtleben Chemie GmbH), 3.7 parts by weight of butyl glycol, and 0.3 part by weight of Agitan 282 (available from Münzing Chemie GmbH) and 3 parts by weight of deionized water.

### 3.5 Production of a Steatite Paste P5

The steatite paste P5 is produced from 49.7 parts by weight of an aqueous binder dispersion prepared as per WO 91/15528, page 23, line 26 to page 24, line 24, 28.9 parts by weight of steatite (Microtalc IT extra from Mondo Minerals B.V.), 0.4 part by weight of Agitan 282 (available from Münzing Chemie GmbH), 1.45 parts by weight of Disperbyk®-184 (available from BYK-Chemie GmbH), 3.1 parts by weight of a commercial polyether (Pluriol® P900, available from BASF SE), and 16.45 parts by weight of deionized water.

### 4. Preparation of Further Intermediates

### 4.1 Preparation of a Mixing Varnish ML1

In accordance with patent specification EP 1534792 B1, column 11, lines 1-13, 81.9 parts by weight of deionized water, 2.7 parts by weight of Rheovis® AS 1130 (available from BASF SE), 8.9 parts by weight of 2,4,7,9-tetramethyl-5-decynediol, 52% in BG (available from BASF SE), 3.2 parts by weight of Dispex Ultra FA 4437 (available from BASF SE), and 3.3 parts by weight of 10% dimethylethanolamine in water are mixed with one another; the resulting mixture is subsequently homogenized.

### 4.2 Preparation of a Mixing Varnish ML2

47.38 parts by weight of the aqueous dispersion AD1, 42.29 parts by weight of deionized water, 6.05 parts by weight of 2,4,7,9-tetramethyl-5-decynediol, 52% in butyl glycol (available from BASF SE), 2.52 parts by weight of Dispex Ultra FA 4437 (available from BASF SE), 0.76 part by weight of Rheovis® AS 1130 (available from BASF SE) and 1.0 part by weight of 10% dimethylethanolamine in water are mixed with one another and the resulting mixture is subsequently homogenized.

ML1 and ML2 are used for producing effect pigment pastes.

### 5. Production of Aqueous Basecoat Materials

### 5.1 Production of Waterborne Basecoat Materials WBL1 to WBL6

The components listed under “Aqueous phase” in table 5.1 are stirred together in the order stated to form an aqueous mixture. In the next step, a premix is produced from the components listed under “Aluminum pigment premix”. This premix is added to the aqueous mixture. Stirring takes place for 10 minutes after the addition. Then deionized water and dimethylethanolamine are used to set a pH of 8 and a spray viscosity of 85±5 mPa·s under a shearing load of 1000 s⁻¹, measured using a rotational viscometer (Rheolab QC with C-LTD80/QC heating system from Anton Paar) at 23° C.

Within the series WBL1 to WBL3, the fraction of aluminum pigment and hence the pigment/binder ratio was increased in each case. In comparison to WBL1, the fraction of pigment was doubled in WBL2 and trebled in WBL3. The same applies to the series WBL4 to WBL6: in comparison to WBL4, the fraction of pigment was doubled in WBL5 and trebled in WBL6.

TABLE 5.1
Production of waterborne basecoat materials WBL1-WBL6

| | WBL1 | WBL2 | WBL3 | WBL4 | WBL5 | WBL6 |
|---|---|---|---|---|---|---|
| Aqueous phase: | | | | | | |
| 3% Na Mg phyllosilicate solution | 16.10 | 12.89 | 9.68 | — | — | — |
| Deionized water | 12.84 | 10.26 | 7.72 | 12.83 | 10.28 | 7.73 |
| 1-Propoxy-2-propanol | 2.67 | 2.14 | 1.61 | — | — | — |
| n-Butoxypropanol | 2.09 | 1.67 | 1.25 | — | — | — |
| 2-Ethylhexanol | 3.17 | 2.54 | 1.91 | 2.17 | 1.74 | 1.30 |
| Aqueous binder dispersion AD1 | 25.27 | 20.23 | 15.20 | 16.10 | 12.89 | 9.68 |
| Aqueous polyurethane-polyurea | 7.34 | 5.88 | 4.41 | 32.36 | 25.90 | 19.46 |
| dispersion PD1 | | | | | | |
| Polyester prepared as per page 28, lines | 4.25 | 3.41 | 2.56 | 5.34 | 4.27 | 3.21 |
| 13 to 33 (example BE1) WO | | | | | | |
| 2014/033135 A2 | | | | | | |
| Melamine-formaldehyde resin (Cymel ® | 3.17 | 2.54 | 1.91 | 3.17 | 2.54 | 1.91 |
| 203 from Allnex) | | | | | | |
| 10% dimethylethanolamine in water | 0.75 | 0.60 | 0.45 | 1.34 | 1.06 | 0.80 |
| Pluriol ® P900, available from BASF SE | 0.67 | 0.53 | 0.40 | — | — | — |
| 2,4,7,9-Tetramethyl-5-decynediol, 52% in | — | — | — | 1.00 | 0.80 | 0.60 |
| BG (available from BASF SE) | | | | | | |
| Isobutanol | 3.50 | 2.80 | 2.11 | | | |
| Butyl glycol | 1.25 | 1.00 | 0.75 | 9.09 | 7.28 | 5.47 |
| 50 wt % solution of Rheovis ® PU1250 in | 0.33 | 0.27 | 0.20 | — | — | — |
| butyl glycol (Rheovis ® PU1250 available | | | | | | |
| from BASF SE) | | | | | | |
| Aluminum pigment premix: | | | | | | |
| Mixing varnish ML1 | 12.45 | 24.93 | 37.38 | 12.45 | 24.93 | 37.38 |
| Mixture of two commercial aluminum | 4.15 | 8.31 | 12.46 | 4.15 | 8.31 | 12.46 |
| pigments, available from Altana-Eckart | | | | | | |
| (Stapa ® Hydrolux 2153 & Hydrolux 600 | | | | | | |
| in ratio of 1:1) | | | | | | |
| Total: | 100.00 | 100.00 | 100.00 | 100.00 | 100.00 | 100.00 |
| Pigment/binder ratio: | 0.18 | 0.44 | 0.86 | 0.12 | 0.29 | 0.56 |

### 5.2 Production of Waterborne Basecoat Materials WBL7 and WBL8

The components listed under “Aqueous phase” in table 5.2 are stirred together in the order stated to form an aqueous mixture. In the next step, a premix is produced in each case from the components listed under “Aluminum pigment premix” and “Mica pigment premix”. These premixes are added separately to the aqueous mixture. Stirring takes place for 10 minutes after the addition of each premix. Then deionized water and dimethylethanolamine are used to set a pH of 8 and a spray viscosity of 95±10 mPa·s under a shearing load of 1000 s⁻¹, measured using a rotational viscometer (Rheolab QC with C-LTD80/QC heating system from Anton Paar) at 23° C.

TABLE 5.2
Production of waterborne basecoat materials WBL7 and WBL8

| | WBL7 | WBL8 |
|---|---|---|
| Aqueous phase: | | |
| 3% Na Mg phyllosilicate solution | 14.4 | 13.4 |
| Deionized water | 11.5 | 11.4 |
| 1-Propoxy-2-propanol | 2.4 | — |
| n-Butoxypropanol | 1.9 | 1.1 |
| 2-Ethylhexanol | 2.8 | — |
| Aqueous binder dispersion AD1 | 22.6 | — |
| Aqueous polyurethane-polyurea dispersion | 6.6 | — |
| PD1 | | |
| Polyurethane dispersion prepared as per | — | 29.3 |
| WO 92/15405, page 13, line 13 to page | | |
| 15, line 13 | | |
| Polyester prepared as per page 28, lines | 3.8 | 1.5 |
| 13 to 33 (example BE1) WO 2014/033135 A2 | | |
| Polyester prepared as per example D, column | — | 2.2 |
| 16, lines 37-59 of DE 40 09 858 A1 | | |
| Polyurethane-modified polyacrylate prepared | — | 2.2 |
| as per page 7, line 55 to page 8, line 23 of DE | | |
| 4437535 A1 | | |
| Melamine-formaldehyde resin (Cymel ® 203 | 2.8 | — |
| from Allnex) | | |
| Melamine-formaldehyde resin (Maprenal ® | — | 3.3 |
| 909/93IB from INEOS Melamines GmbH) | | |
| 10% dimethylethanolamine in water | 0.7 | 1.0 |
| Pluriol ® P900, available from BASF SE | 0.6 | — |
| 2,4,7,9-Tetramethyl-5-decynediol, 52% in BG | — | 0.2 |
| (available from BASF SE) | | |
| Isobutanol | 3.1 | — |
| Isopropanol | — | 1.8 |
| Butyl glycol | 1.1 | 2.6 |
| Hydrosol A170, available from DHC Solvent | — | 0.4 |
| Chemie GmbH | | |
| Methoxypropanol | — | 2.0 |
| Isopar ® L, available from Exxon Mobil | — | 1.5 |
| 50 wt % solution of Rheovis ® PU1250 | 0.3 | 0.3 |
| in butyl glycol | | |
| (Rheovis ® PU1250 available from BASF SE) | | |
| BYK-347 ® from Altana/BYK-Chemie GmbH | — | 0.4 |
| Yellow paste P1 | 1.7 | 1.7 |
| White paste P2 | 0.7 | 0.7 |
| Black paste P3 | 3.4 | 3.4 |
| Barium sulfate paste P4 | 0.7 | 0.7 |
| Steatite paste P5 | 1.4 | 1.4 |
| Aluminum pigment premix: | | |
| Mixing varnish ML1 | 12.2 | 12.2 |
| Mixture of two commercial aluminum | 4.0 | 4.0 |
| pigments, available from Altana-Eckart | | |
| (Stapa ® Hydrolux 2153 & | | |
| Hydrolux 600 in ratio of 1:1) | | |
| Mica pigment premix: | | |
| Mixing varnish ML1 | 1.0 | 1.0 |
| Commercial mica pigment Mearlin ® Exterior | 0.3 | 0.3 |
| Fine Russet 459V (from BASF SE) | | |
| Total: | 100.0 | 100.0 |
| Pigment/binder ratio: | 0.3 | 0.3 |
| Solids content (adjusted): | 21.6% | 21.7% |

### 5.3 Production of Waterborne Basecoat Materials WBL9 to WBL12

The components listed under “Aqueous phase” in table 5.3 are stirred together in the order stated to form an aqueous mixture. In the next step, a premix is produced from the components listed under “Aluminum pigment premix”. This premix is added to the aqueous mixture. Stirring takes place for 10 minutes after the addition. Then deionized water and dimethylethanolamine are used to set a pH of 8 and a spray viscosity of 85±5 mPa·s under a shearing load of 1000 s⁻¹, measured using a rotational viscometer (Rheolab QC with C-LTD80/QC heating system from Anton Paar) at 23° C.

Within the series WBL9 to WBL10, the fraction of aluminum pigment and hence the pigment/binder ratio was lowered in each case. The same is true of the series WBL11 to WBL12.

TABLE 5.3
Production of waterborne basecoat materials WBL9 to WBL12

| | WBL9 | WBL10 | WBL11 | WBL12 |
|---|---|---|---|---|
| Aqueous phase: | | | | |
| 3% Na Mg phyllosilicate | 17.87 | 17.87 | 17.87 | 17.87 |
| solution | | | | |
| Deionized water | 12.23 | 16.74 | 12.07 | 16.68 |
| 2-Ethylhexanol | 1.99 | 1.99 | 1.99 | 1.99 |
| Polyurethane dispersion | 25.41 | 25.41 | 25.41 | 25.41 |
| prepared as per WO | | | | |
| 92/15405, page 13, line | | | | |
| 13 to page 15, line 13 | | | | |
| Daotan ® VTW 6464, | 1.59 | 1.59 | 1.59 | 1.59 |
| available from Allnex | | | | |
| Polyurethane-modified | 2.78 | 2.78 | 2.78 | 2.78 |
| polyacrylate | | | | |
| prepared as per | | | | |
| page 7, line 55 to page 8, | | | | |
| line 23 of DE 4437535 | | | | |
| A1 3 wt % aqueous | 5.08 | 5.08 | 5.08 | 5.08 |
| Rheovis ® | | | | |
| AS 1130 solution, | | | | |
| Rheovis ® AS 1130 | | | | |
| available from BASF SE | | | | |
| Melamine-formaldehyde | 3.57 | 3.57 | 3.57 | 3.57 |
| resin (Cymel ® 1133 | | | | |
| from Allnex) | | | | |
| 10% dimethylethanol- | 0.95 | 0.95 | 0.95 | 0.95 |
| amine in water | | | | |
| Pluriol ® P900, available | 0.40 | 0.40 | 0.40 | 0.40 |
| from BASF SE | | | | |
| 2,4,7,9-Tetramethyl-5- | 1.35 | 1.35 | 1.35 | 1.35 |
| decynediol, 52% in BG | | | | |
| (available from | | | | |
| BASF SE) | | | | |
| Triisobutyl phosphate | 1.19 | 1.19 | 1.19 | 1.19 |
| Isopropanol | 1.95 | 1.95 | 1.95 | 1.95 |
| Butyl glycol | 2.54 | 2.54 | 2.54 | 2.54 |
| 50 wt % solution of | 0.24 | 0.24 | 0.24 | 0.24 |
| Rheovis ® PU1250 | | | | |
| in butyl | | | | |
| glycol (Rheovis ® | | | | |
| PU1250 available from | | | | |
| BASF SE) | | | | |
| Tinuvin ® 123, available | 0.64 | 0.64 | 0.64 | 0.64 |
| from BASF SE | | | | |
| Tinuvin ® 384-2, | 0.40 | 0.40 | 0.40 | 0.40 |
| available from BASF SE | | | | |
| Aluminum pigment | | | | |
| premix: | | | | |
| Aluminum pigment | 7.22 | 2.71 | — | — |
| Stapa ® | | | | |
| Hydrolux 600, available | | | | |
| from Altana-Eckart | | | | |
| Aluminum pigment | — | — | 7.38 | 2.77 |
| Stapa ® | | | | |
| Hydrolux 200, available | | | | |
| from Altana-Eckart | | | | |
| Butyl glycol | 9.60 | 9.60 | 9.60 | 9.60 |
| Polyester prepared as per | 3.00 | 3.00 | 3.00 | 3.00 |
| example D, column 16, | | | | |
| lines 37-59 of | | | | |
| DE 40 09 858 A1 | | | | |
| Total: | 100.00 | 100.00 | 100.00 | 100.00 |
| Pigment/binder ratio: | 0.35 | 0.13 | 0.35 | 0.13 |

### 5.4 Production of Waterborne Basecoat Materials WBL13 to WBL16

The components listed under “Aqueous phase” in table 5.4 are stirred together in the order stated to form an aqueous mixture. In the next step, a premix is produced from the components listed under “Aluminum pigment premix”. This premix is added to the aqueous mixture. Stirring takes place for 10 minutes after the addition. Then deionized water and dimethylethanolamine are used to set a pH of 8 and a spray viscosity of 85±5 mPa·s under a shearing load of 1000 s⁻¹, measured using a rotational viscometer (Rheolab QC with C-LTD80/QC heating system from Anton Paar) at 23° C.

Within the series WBL13 to WBL14, the fraction of aluminum pigment and hence the pigment/binder ratio was lowered in each case. The same is true of the series WBL15 to WBL16.

TABLE 5.4
Production of waterborne basecoat materials WBL13 to WBL16

| | WBL13 | WBL14 | WBL15 | WBL16 |
|---|---|---|---|---|
| Aqueous phase: | | | | |
| 3% Na Mg phyllosilicate | 14.45 | 14.45 | 14.45 | 14.45 |
| Solution | | | | |
| Deionized water | 8.99 | 13.50 | 8.83 | 13.44 |
| 2-Ethylhexanol | 1.91 | 1.91 | 1.91 | 1.91 |
| Aqueous binder dispersion | 26.33 | 26.33 | 26.33 | 26.33 |
| AD1 | | | | |
| Aqueous polyurethane- | 6.09 | 6.09 | 6.09 | 6.09 |
| polyurea dispersion PD1 | | | | |
| Polyester prepared as per | 3.01 | 3.01 | 3.01 | 3.01 |
| page 28, lines 13 to 33 | | | | |
| (example BE1) WO 2014/ | | | | |
| 033135 A2 | | | | |
| Melamine-formaldehyde | 6.67 | 6.67 | 6.67 | 6.67 |
| resin (Cymel ® 203 | | | | |
| from Allnex) | | | | |
| Deionized water | 1.69 | 1.69 | 1.69 | 1.69 |
| Rheovis ® AS 1130, | 0.22 | 0.22 | 0.22 | 0.22 |
| available from BASF SE | | | | |
| 10% dimethylethanolamine | 0.51 | 0.51 | 0.51 | 0.51 |
| in water | | | | |
| 2,4,7,9-Tetramethyl-5- | 0.29 | 0.29 | 0.29 | 0.29 |
| decynediol, 52% in BG | | | | |
| (available from BASF SE) | | | | |
| Butyl glycol | 3.89 | 3.89 | 3.89 | 3.89 |
| 50 wt % solution of | | | | |
| Rheovis ® | | | | |
| PU1250 in butyl | | | | |
| glycol (Rheovis ® | 0.07 | 0.07 | 0.07 | 0.07 |
| PU1250 available from | | | | |
| BASF SE) | | | | |
| Aluminum pigment premix: | | | | |
| Mixing varnish ML2 | 18.66 | 18.66 | 18.66 | 18.66 |
| Aluminum pigment | 7.22 | 2.71 | — | — |
| Stapa ® Hydrolux | | | | |
| 600, available from Altana- | | | | |
| Eckart | | | | |
| Aluminum pigment | — | — | 7.38 | 2.77 |
| Stapa ® Hydrolux | | | | |
| 200, available from Altana- | | | | |
| Eckart | | | | |
| Total: | 100.00 | 100.00 | 100.00 | 100.00 |
| Pigment/binder ratio: | 0.25 | 0.09 | 0.25 | 0.09 |

### 5.5 Production of Waterborne Basecoat Materials WBL17 to WBL24, WBL17a and WBL21a

The components listed under “Aqueous phase” in table 5.5 are stirred together in the order stated to form an aqueous mixture. In the next step, a premix is produced from the components listed under “Aluminum pigment premix”. This premix is added to the aqueous mixture. Stirring takes place for 10 minutes after the addition. Then deionized water and dimethylethanolamine are used to set a pH of 8 and a spray viscosity of 85±5 mPa·s under a shearing load of 1000 s⁻¹, measured using a rotational viscometer (Rheolab QC with C-LTD80/QC heating system from Anton Paar) at 23° C.

In addition, samples WBL17 and WBL21 were adjusted to a spray viscosity of 120±5 mPa·s under a shearing load of 1000 s⁻¹, measured using a rotational viscometer (Rheolab QC with C-LTD80/QC heating system from Anton Paar) at 23° C. (resulting in WBL17a and WBL21a, respectively).

TABLE 5.5
Production of waterborne basecoat materials WBL17 to WBL24

| | WBL17 | WBL18 | WBL19 | WBL 20 | WBL 21 | WBL22 | WBL23 | WBL24 |
|---|---|---|---|---|---|---|---|---|
| Aqueous phase: | | | | | | | | |
| 3% Na/Mg phyllosilicate | 17.87 | 17.87 | 17.87 | 17.87 | 17.87 | 17.87 | 17.87 | 17.87 |
| solution | | | | | | | | |
| Deionized water | 11.45 | 12.07 | 16.45 | 16.68 | 11.61 | 12.07 | 16.51 | 16.68 |
| 2-Ethylhexanol | 1.99 | 1.99 | 1.99 | 1.99 | 1.99 | 1.99 | 1.99 | 1.99 |
| Polyurethane dispersion, | 25.41 | 25.41 | 25.41 | 25.41 | 25.41 | 25.41 | 25.41 | 25.41 |
| prepared as per | | | | | | | | |
| WO 92/15405, page 13, line | | | | | | | | |
| 13 to page 15, line 13 | | | | | | | | |
| Daotan ® VTW 6464, available | 1.59 | 1.59 | 1.59 | 1.59 | 1.59 | 1.59 | 1.59 | 1.59 |
| from Allnex | | | | | | | | |
| Polyurethane-modified | 2.78 | 2.78 | 2.78 | 2.78 | 2.78 | 2.78 | 2.78 | 2.78 |
| polyacrylate; prepared as per | | | | | | | | |
| page 7, line 55 to page 8, line | | | | | | | | |
| 23 of DE 4437535 A1 | | | | | | | | |
| 3 wt % aqueous Rheovis ® | 5.08 | 5.08 | 5.08 | 5.08 | 5.08 | 5.08 | 5.08 | 5.08 |
| AS 1130 solution, Rheovis ® | | | | | | | | |
| AS 1130 available from BASF | | | | | | | | |
| SE | | | | | | | | |
| Melamine-formaldehyde resin | 3.57 | 3.57 | 3.57 | 3.57 | 3.57 | 3.57 | 3.57 | 3.57 |
| (Cymel ® 1133 from Allnex) | | | | | | | | |
| 10% dimethylethanolamine in | 0.95 | 0.95 | 0.95 | 0.95 | 0.95 | 0.95 | 0.95 | 0.95 |
| water | | | | | | | | |
| Pluriol ® P900, available from | 0.40 | 0.40 | 0.40 | 0.40 | 0.40 | 0.40 | 0.40 | 0.40 |
| BASF SE | | | | | | | | |
| 2,4,7,9-Tetramethyl-5- | 1.35 | 1.35 | 1.35 | 1.35 | 1.35 | 1.35 | 1.35 | 1.35 |
| decynediol, 52% in BG | | | | | | | | |
| (available from BASF SE) | | | | | | | | |
| Triisobutyl phosphate | 1.19 | 1.19 | 1.19 | 1.19 | 1.19 | 1.19 | 1.19 | 1.19 |
| Isopropanol | 1.95 | 1.95 | 1.95 | 1.95 | 1.95 | 1.95 | 1.95 | 1.95 |
| Butyl glycol | 2.54 | 2.54 | 2.54 | 2.54 | 2.54 | 2.54 | 2.54 | 2.54 |
| 50 wt % solution of Rheovis ® | 0.24 | 0.24 | 0.24 | 0.24 | 0.24 | 0.24 | 0.24 | 0.24 |
| PU1250 in butyl glycol | | | | | | | | |
| (Rheovis ® PU1250 available | | | | | | | | |
| from BASF SE) | | | | | | | | |
| Tinuvin ® 123, available from | 0.64 | 0.64 | 0.64 | 0.64 | 0.64 | 0.64 | 0.64 | 0.64 |
| BASF SE | | | | | | | | |
| Tinuvin ® 384-2, available | 0.40 | 0.40 | 0.40 | 0.40 | 0.40 | 0.40 | 0.40 | 0.40 |
| from BASF SE | | | | | | | | |
| Aluminum pigment premix: | | | | | | | | |
| Aluminum pigment Stapa ® IL | 8.00 | — | 3.00 | — | — | — | — | — |
| HYDROLAN 9157, available | | | | | | | | |
| from Altana-Eckart | | | | | | | | |
| Aluminum pigment Stapa ® IL | — | 7.38 | — | 2.77 | — | — | — | — |
| HYDROLAN 214 NO. 55, | | | | | | | | |
| available from Altana-Eckart | | | | | | | | |
| Aluminum pigment Stapa ® IL | — | — | — | — | 7.84 | — | 2.94 | — |
| HYDROLAN 2197, available | | | | | | | | |
| from Altana-Eckart | | | | | | | | |
| Aluminum pigment Stapa ® IL | — | — | — | — | — | 7.38 | — | 2.77 |
| HYDROLAN 2153, available | | | | | | | | |
| from Altana-Eckart | | | | | | | | |
| Butyl glycol | 9.60 | 9.60 | 9.60 | 9.60 | 9.60 | 9.60 | 9.60 | 9.60 |
| Polyester; prepared as per | 3.00 | 3.00 | 3.00 | 3.00 | 3.00 | 3.00 | 3.00 | 3.00 |
| example D, column 16, | | | | | | | | |
| lines 37-59 of | | | | | | | | |
| DE 40 09 858 A1 | | | | | | | | |
| Total: | 100.00 | 100.00 | 100.00 | 100.00 | 100.00 | 100.00 | 100.00 | 100.00 |
| Pigment/binder ratio: | 0.35 | 0.13 | 0.35 | 0.13 | 0.35 | 0.13 | 0.35 | 0.13 |

### 5.6 Production of Waterborne Basecoat Materials WBL25 to WBL30

The components listed under “Aqueous phase” in table 5.6 are stirred together in the order stated to form an aqueous mixture. In the next step, a premix is produced in each case from the components listed under “Aluminum pigment premix”. These premixes are added separately to the aqueous mixture. Stirring takes place for 10 minutes after the addition of each premix. Then deionized water and dimethylethanolamine are used to set a pH of 8 and a spray viscosity of 85±10 mPa·s under a shearing load of 1000 s⁻¹, measured using a rotational viscometer (Rheolab QC with C-LTD80/QC heating system from Anton Paar) at 23° C.

TABLE 5.6
Production of waterborne basecoat materials WBL25 to WBL30

| | WBL25 | WBL26 | WBL27 | WBL28 | WBL29 | WBL30 |
|---|---|---|---|---|---|---|
| Aqueous phase: | | | | | | |
| 3% Na/Mg phyllosilicate solution | 14.45 | 14.45 | 14.45 | 14.45 | 14.45 | 14.45 |
| Deionized water | 8.21 | 8.83 | 13.21 | 13.44 | 8.21 | 13.21 |
| 2-Ethylhexanol | 1.91 | 1.91 | 1.91 | 1.91 | 1.91 | 1.91 |
| Aqueous binder dispersion AD1 | 26.33 | 26.33 | 26.33 | 26.33 | 26.33 | 26.33 |
| Aqueous polyurethane-polyurea | 6.09 | 6.09 | 6.09 | 6.09 | 6.09 | 6.09 |
| dispersion PD1 | | | | | | |
| Polyester; prepared as per page 28, | 3.01 | 3.01 | 3.01 | 3.01 | 3.01 | 3.01 |
| lines 13 to 33 (example BE1) | | | | | | |
| WO 2014/033135 A2 | | | | | | |
| Melamine-formaldehyde resin (Cymel ® | 6.67 | 6.67 | 6.67 | 6.67 | 6.67 | 6.67 |
| 203 from Allnex) | | | | | | |
| Deionized water | 1.69 | 1.69 | 1.69 | 1.69 | 1.69 | 1.69 |
| Rheovis ® AS 1130, available from | 0.22 | 0.22 | 0.22 | 0.22 | 0.22 | 0.22 |
| BASF SE | | | | | | |
| 10% dimethylethanolamine in water | 0.51 | 0.51 | 0.51 | 0.51 | 0.51 | 0.51 |
| 2,4,7,9-Tetramethyl-5-decynediol, 52% | 0.29 | 0.29 | 0.29 | 0.29 | 0.29 | 0.29 |
| in BG (available from BASF SE) | | | | | | |
| Butyl glycol | 3.89 | 3.89 | 3.89 | 3.89 | 3.89 | 3.89 |
| 50 wt % solution of Rheovis ® PU1250 in | 0.07 | 0.07 | 0.07 | 0.07 | 0.07 | 0.07 |
| butyl glycol (Rheovis ® PU1250 available | | | | | | |
| from BASF SE) | | | | | | |
| Aluminum pigment premix: | | | | | | |
| Mixing varnish ML2 | 18.66 | 18.66 | 18.66 | 18.66 | 18.66 | 18.66 |
| Aluminum pigment Stapa ® IL | 8.00 | — | 3.00 | — | — | — |
| HYDROLAN 9157, available from | | | | | | |
| Altana-Eckart | | | | | | |
| Aluminum pigment Stapa ® IL | — | 7.38 | — | 2.77 | — | — |
| HYDROLAN 214 NO. 55, available from | | | | | | |
| Altana-Eckart | | | | | | |
| Aluminum pigment Stapa ® HYDROLUX | — | — | — | — | 8.00 | 3.00 |
| 2197, available from Altana-Eckart | | | | | | |
| Total: | 100.00 | 100.00 | 100.00 | 100.00 | 100.00 | 100.00 |
| Pigment/binder ratio: | 0.25 | 0.09 | 0.25 | 0.09 | 0.25 | 0.09 |

### 5.7 Production of Waterborne Basecoat Materials WBL31 and WBL31a

The components listed under “Aqueous phase” in table 5.7 are stirred together in the order stated to form an aqueous mixture. In the next step, a premix is produced from the components listed under “Aluminum pigment premix”. This premix is added to the aqueous mixture. Stirring takes place for 10 minutes after the addition. Then deionized water and dimethylethanolamine are used to set a pH of 8 and a spray viscosity of 130±5 mPa·s (WBL31) or 80±5 mPa·s (WBL31a) under a shearing load of 1000 s⁻¹, measured using a rotational viscometer (Rheolab QC with C-LTD80/QC heating system from Anton Paar) at 23° C. In the case of WBL31a, this is achieved using a greater amount of deionized water.

TABLE 5.7
Production of waterborne basecoat materials WBL31
and WBL31a

| | WBL31 | WBL31a |
|---|---|---|
| Aqueous phase: | | |
| 3% Na/Mg phyllosilicate | 17.00 | 17.00 |
| solution | | |
| Deionized water | 10.89 | 10.89 |
| 2-Ethylhexanol | 1.89 | 1.89 |
| Polyurethane dispersion, | 24.17 | 24.17 |
| prepared as per WO 92/15405, | | |
| page 13, line 13 to page 15, | | |
| line 13 | | |
| Daotan ® VTW 6464, | 1.51 | 1.51 |
| available from Allnex | | |
| Polyurethane-modified | 2.64 | 2.64 |
| polyacrylate; prepared as | | |
| per page 7, line 55 to page | | |
| 8, line 23 of DE 4437535 A1 | | |
| 3 wt % aqueous Rheovis ® | 4.83 | 4.83 |
| AS 1130 solution, | | |
| Rheovis ® AS | | |
| 1130 available from BASF SE | | |
| Melamine-formaldehyde | 3.40 | 3.40 |
| resin (Cymel ® 1133 | | |
| from Allnex) | | |
| 10% dimethylethanolamine in water | 0.90 | 0.90 |
| Pluriol ® P900, | 0.38 | 0.38 |
| available from BASF SE | | |
| 2,4,7,9-Tetramethyl-5- | 1.28 | 1.28 |
| decynediol, 52% in BG | | |
| (available from BASF SE) | | |
| Triisobutyl phosphate | 1.13 | 1.13 |
| Isopropanol | 1.85 | 1.85 |
| Butyl glycol | 2.42 | 2.42 |
| 50 wt % solution of | 0.23 | 0.23 |
| Rheovis ® PU1250 | | |
| in butyl glycol | | |
| (Rheovis ® PU1250 | | |
| available from BASF SE) | | |
| Tinuvin ® 123, available | 0.61 | 0.61 |
| from BASF SE | | |
| Tinuvin ® 384-2, available | 0.38 | 0.38 |
| from BASF SE | | |
| Deionized water | 7.91 | 12.10 |
| Aluminum pigment premix: | | |
| Aluminum pigment Stapa ® | 3.26 | 3.26 |
| HYDROLUX VP56450, | | |
| available from Altana-Eckart | | |
| Aluminum pigment Stapa ® | 1.30 | 1.30 |
| HYDROLUX 1071, | | |
| available from Altana-Eckart | | |
| Butyl glycol | 9.21 | 9.21 |
| Polyester; prepared as per | 2.79 | 2.79 |
| example D, column 16, | | |
| lines 37-59 of DE 40 09 858 A1 | | |
| Total: | 100.00 | 104.19 |
| Pigment/binder ratio: | 0.23 | 0.23 |

### 5.8 Production of Waterborne Basecoat Materials WBL32 and WBL33

The components listed under “Aqueous phase” in table 5.8 are stirred together in the order stated to form an aqueous mixture. In the next step, a premix is produced from the components listed under “Butyl glycol/polyester mixture (3:1)”. This premix is added to the aqueous mixture. Stirring takes place for 10 minutes after the addition. Then deionized water and dimethylethanolamine are used to set a pH of 8 and a spray viscosity of 135±5 mPa·s under a shearing load of 1000 s⁻¹, measured using a rotational viscometer (Rheolab QC with C-LTD80/QC heating system from Anton Paar) at 23° C.

TABLE 5.8
Production of waterborne basecoat materials WBL32
and WBL33

| | WBL32 | WBL33 |
|---|---|---|
| Aqueous phase: | | |
| 3% Na/Mg phyllosilicate solution | 20.82 | 20.82 |
| Deionized water | 13.34 | 13.34 |
| 2-Ethylhexanol | 2.32 | 2.32 |
| Polyurethane dispersion, prepared | 29.60 | 29.60 |
| as per WO 92/15405, page 13, line | | |
| 13 to page 15, line 13 | | |
| Daotan ® VTW 6464, | 1.85 | 1.85 |
| available from Allnex | | |
| Polyurethane-modified polyacrylate; | 3.24 | 3.24 |
| prepared as per page 7, line 55 to | | |
| page 8, line 23 of DE 4437535 A1 | | |
| 3 wt % aqueous Rheovis ® | 5.92 | 5.92 |
| AS 1130 solution, Rheovis ® | | |
| AS 1130 available from BASF SE | | |
| Melamine-formaldehyde resin | 4.16 | 4.16 |
| (Cymel ® 1133 from | | |
| Allnex) | | |
| 10% dimethylethanolamine in | 1.11 | 1.11 |
| water | | |
| Pluriol ® P900, available | 0.47 | 0.47 |
| from BASF SE | | |
| 2,4,7,9-Tetramethyl-5-decynediol, | 1.57 | 1.57 |
| 52% in BG (available from BASF | | |
| SE) | | |
| Triisobutyl phosphate | 1.39 | 1.39 |
| Isopropanol | 2.27 | 2.27 |
| Butyl glycol | 2.96 | 2.96 |
| 50 wt % solution of Rheovis ® | 0.28 | 0.28 |
| PU1250 in butyl glycol | | |
| (Rheovis ® PU1250 | | |
| available from BASF SE) | | |
| Tinuvin ® 123, available | 0.75 | 0.75 |
| from BASF SE | | |
| Tinuvin ® 384-2, | 0.47 | 0.47 |
| available from BASF SE | | |
| Butyl glycol/polyester mixture (3:1) | | |
| Butyl glycol | 5.63 | 9.38 |
| Polyester; prepared as per example | 1.88 | 3.13 |
| D, column 16, lines 37-59 of | | |
| DE 40 09 858 A1 | | |
| Total: | 100.00 | 105.00 |

### 5.9 Production of Waterborne Basecoat Materials WBL34, WBL35, WBL34a and WBL35a

The components listed under “Aqueous phase” in table 5.9 are stirred together in the order stated to form an aqueous mixture. Following 10 minutes of stirring, deionized water and dimethylethanolamine are then used to set a pH of 8 and a spray viscosity of 120±5 mPa·s (WBL34 and WBL35) or 80±5 mPa·s (WBL34a and WBL35a) under a shearing load of 1000 s⁻¹, measured using a rotational viscometer (Rheolab QC with C-LTD80/QC heating system from Anton Paar) at 23° C.

TABLE 5.9
Production of waterborne basecoat materials WBL34,
WBL34a, WBL35 and WBL35a

| | WBL34 | WBL35 | WBL34a | WBL35a |
|---|---|---|---|---|
| Aqueous phase: | | | | |
| 3% Na/Mg phyllosilicate | 19.69 | 19.69 | 19.69 | 19.69 |
| solution | | | | |
| Deionized water | 12.62 | 12.62 | 12.62 | 12.62 |
| 2-Ethylhexanol | 2.19 | 2.19 | 2.19 | 2.19 |
| Polyurethane dispersion, | 28.00 | 28.00 | 28.00 | 28.00 |
| prepared as per WO 92/ | | | | |
| 15405, page 13, line 13 to | | | | |
| page 15, line 13 | | | | |
| Daotan ® VTW | 1.75 | 1.75 | 1.75 | 1.75 |
| 6464, available from Allnex | | | | |
| Polyurethane-modified | 3.06 | 3.06 | 3.06 | 3.06 |
| polyacrylate; prepared as per | | | | |
| page 7, line 55 to page 8, | | | | |
| line 23 of DE 4437535 A1 | | | | |
| 3 wt % aqueous Rheovis ® | 5.60 | 5.60 | 5.60 | 5.60 |
| AS 1130 solution, | | | | |
| Rheovis ® AS 1130 | | | | |
| available from BASF SE | | | | |
| Melamine-formaldehyde | 3.93 | 3.93 | 3.93 | 3.93 |
| resin | | | | |
| (Cymel ® 1133 from | | | | |
| Allnex) | | | | |
| 10% dimethylethanolamine | 1.05 | 1.05 | 1.05 | 1.05 |
| in water | | | | |
| Pluriol ® P900, available | 0.44 | 0.44 | 0.44 | 0.44 |
| from BASF SE | | | | |
| 2,4,7,9-Tetramethyl-5- | 1.49 | 1.49 | 1.49 | 1.49 |
| decynediol, 52% in BG | | | | |
| (available from BASF SE) | | | | |
| Triisobutyl phosphate | 1.31 | 1.31 | 1.31 | 1.31 |
| Isopropanol | 2.15 | 2.15 | 2.15 | 2.15 |
| Butyl glycol | 2.80 | 2.80 | 2.80 | 2.80 |
| 50 wt % solution of | 0.26 | 0.26 | 0.26 | 0.26 |
| Rheovis ® PU1250 in butyl | | | | |
| glycol (Rheovis ® PU1250 | | | | |
| available from BASF SE) | | | | |
| Tinuvin ® 123, | 0.71 | 0.71 | 0.71 | 0.71 |
| available from BASF SE | | | | |
| Tinuvin ® 384-2, | 0.44 | 0.44 | 0.44 | 0.44 |
| available from BASF SE | | | | |
| Butyl glycol | — | 12.50 | — | 12.50 |
| Deionized water | — | — | 3.00 | 3.00 |
| Total: | 87.50 | 100.00 | 90.50 | 103.00 |

6. Investigations and Comparison of the Properties of the Aqueous Basecoat Materials and of their Resultant Films and Coatings

### 6.1 Comparison Between Waterborne Basecoat Materials WBL1 to WBL6 in Thread Lifetime and Mean Filament Length at the Bell Edge

The investigations on the waterborne basecoat materials WBL1 to WBL6 with regard to thread lifetime and mean filament length and wetness took place in accordance with the methods described above. The series for comparison with one another in each case are the series WBL1 to WBL3 and WBL4 to WBL6, since here, in ascending numerical order of the coating materials, an increase was carried out in the fraction of pigment present in the material and, consequently, in the pigment/binder ratio. Table 6.1 summarizes the results.

TABLE 6.1
Comparison of thread lifetime and mean filament length and wetness

| | Waterborne basecoat material | | | | | |
|---|---|---|---|---|---|---|
| | WBL1 | WBL2 | WBL3 | WBL4 | WBL5 | WBL6 |
| CaBER measurement: Thread lifetime [s] | 0.027 | 0.052 | 0.151 | 0.129 | 0.246 | 0.333 |
| Mean filament length at bell edge [μm] | 1610 | 851 | 651 | 1290 | 1090 | 807 |
| Discharge rate: 350 ml/min | | | | | | |
| ESTA bell speed: 20000 rpm | | | | | | |
| Visually determined wetness | 4 | 2 | 1 | 4 | 3 | 2 |

For the samples WBL1 to WBL3 and, similarly, for the samples WBL4 to WBL6, the CaBER measurements show an increasing thread lifetime for increasing concentration of aluminum pigment within the basecoat materials investigated. On the basis of existing literature (e.g., Ergungor et al., J. Non-Newtonian Fluid Mech. 138 (2006), pages 1-6; Thompson et al., J. Non-Newtonian Fluid Mech. 147 (2007), pages 11-22), an obvious conclusion is that this ought also to correlate with an increasingly more difficult breakdown of threads formed at the bell, supposedly leading to a coarser atomization and hence to filaments having higher mean filament lengths. The skilled person typically associates such coarser atomization and hence anticipated higher mean filament lengths with a wetter anticipated coating pattern. Surprisingly, however, in an assessment of the wetness of a coating of WBL1 to WBL3 and, similarly, of WBL4 to WBL6, precisely the opposite was found: that is, the wetness goes down.

The determination of the mean filament length at the bell edge shows that, with increasing concentration of the aluminum pigments within the respective basecoat materials (the concentration increases from WBL1 to WBL3 and from WBL4 to WBL6), smaller filaments with lower filament lengths are formed, this correlating with the wetness judged visually. In other words, as the concentration of the aluminum pigments goes up, the atomization becomes finer overall, since smaller filaments are formed, and the resulting wetness is lower, this being contrary to what would have been expected by a skilled person on the basis of the CaBER measurements and of the increasing thread lifetimes within the series WBL1 to WBL3 and, respectively, WBL4 to WBL6.

### 6.2 Comparison Between Waterborne Basecoat Materials WBL7 and WBL8 in Terms of the Incidence of Pinholes

The investigations on waterborne basecoat materials WBL7 and WBL8 with regard to the assessment of the incidence of pinholes and the filament length are made according to the methods described above. Table 6.2 summarizes the results.

By comparison with WBL7, WBL8 proved to be much more critical with regard to the incidence of pinholes, particularly at a relatively low rotary speed of 23 000 rpm. This behavior correlates with a larger filament length, obtained experimentally in the case of WBL8 in comparison to WBL7 and being a measure in turn of a coarser atomization and of an increased wetness.

TABLE 6.2
Results of the investigations into incidence of pinholes

| Discharge rate: 300 ml/min; speed: 43 000 rpm | | | |
|---|---|---|---|
| | Filament | | |
| WBL | length [mm] | Pinholes | Wetness |
| WBL7 | 0.719 | 0 | 2 |
| WBL8 | 0.763 | >100 | 3 |
| Discharge rate: 400 ml/min; speed: 23 000 rpm | | | |
| | Filament | | |
| WBL | length [mm] | Pinholes | Wetness |
| WBL7 | 1.091 | 0 | 3 |
| WBL8 | 1.124 | >150 | 4 |

6.3 Comparison Between Waterborne Basecoat Materials WBL9 to WBL16 with Regard to the Assessment of Cloudiness, the Incidence of Pinholes, and the Film Thickness-Dependent Leveling

The investigations on waterborne basecoat materials WBL9 to WBL16 with regard to the assessment of cloudiness, of pinholes, and of the film thickness-dependent leveling are made in accordance with the methods described above. Tables 6.3 and 6.4 summarize the results.

TABLE 6.3
Results of the investigations into pinholes and cloudiness
(measured with the cloud-runner from Byk-Gardner)
Discharge rate: 300 ml/min; speed: 43 000 rpm

| | Fila- | | | | |
|---|---|---|---|---|---|
| | ment | | | | |
| | length | | | | |
| WBL | [mm] | Pinholes | Mottling15 | Mottling45 | Mottling60 |
| WBL9 | 0.591 | >100 | 3.8 | 4.2 | 4.1 |
| WBL10 | 0.717 | >100 | 2.9 | 4.4 | 3.5 |
| WBL11 | 0.775 | >100 | 3.4 | 5.3 | 4.9 |
| WBL12 | 0.820 | >100 | 4.8 | 4.4 | 6.3 |
| WBL13 | 0.578 | 0 | 3.3 | 3.9 | 3.9 |
| WBL14 | 0.699 | 0 | 2.7 | 3.8 | 3.4 |
| WBL15 | 0.676 | 0 | 3.8 | 4.7 | 5.6 |
| WBL16 | 0.768 | 0 | 4.1 | 4.4 | 6.1 |

In direct comparison of the sample pairings WBL9 and WBL13, WBL10 and WBL14, WBL11 and WBL15, and WBL12 and WBL16, respectively, each containing the same pigment and also the same amount of pigment, it is found that, at a discharge rate of 300 ml/min and a speed of 43 000 rpm, basecoat materials WBL13 to WBL16 each have a smaller filament length than the corresponding reference sample WBL9 to WBL12 and therefore undergo finer atomization. This is reflected in a significantly better pinholing robustness and also in a lower cloudiness.

TABLE 6.4
Results of the investigations into film thickness-dependent leveling

| | Discharge rate: 300 ml/min; speed: 43 000 rpm | | | | | | | |
|---|---|---|---|---|---|---|---|---|
| | Filament | | | | | | | |
| | length | 10-15 μm | | 15-20 μm | | 20-25 μm | | |
| WBL | [mm] | SW | DOI | SW | DOI | SW | DOI | Wetness |
| WBL9 | 0.591 | 11.5 | 77.3 | 16.1 | 72.2 | 17.2 | 71.6 | 2 |
| WBL11 | 0.775 | 14.7 | 64.6 | 19.9 | 63.8 | 24.0 | 60.8 | 4 |
| WBL10 | 0.717 | 8.60 | 85.05 | 11.90 | 83.82 | 14.30 | 82.73 | 3 |
| WBL12 | 0.820 | 10.40 | 74.35 | 15.10 | 71.44 | 18.70 | 68.37 | 4 |

WBL9 and WBL11 each have a pigment/binder ratio of 0.35, whereas WBL10 and WBL12 each have a pigment/binder ratio of 0.13.

The experimental results show a correlation between the filament lengths, or the resultant atomization properties, and the appearance/leveling, here as a function of the film thickness: on comparison of the samples with identical pigment/binder ratio of 0.35 (WBL9 and WBL11) and 0.13 (WBL10 and WBL12), it is found that a larger filament length, in other words a coarser and hence wetter atomization, leads to poorer leveling, as illustrated by the short wave and DOI figures obtained.

6.4 Comparison Between Waterborne Basecoat Materials WBL9 to WBL20 and WBL25 to WBL28 with Regard to Hiding Power, Clouding Propensity, Pinholes, and Leveling (Effect of Pigment)

The investigations on waterborne basecoat materials WBL9 to WBL20 and WBL25 to WBL28 with regard to hiding power, clouding propensity, pinholes, and leveling were made in accordance with the methods described above. Illustrated specifically in this case is how it is possible to influence the atomization and the resultant coating properties via a replacement of the aluminum pigment used, especially in relation to its particle size. In all of the experiments the discharge rate was 300 ml/min; the rotational speed of the ESTA bell was 43 000 rpm. Tables 6.5 to 6.9 summarize the results.

TABLE 6.5
Results of the investigations into hiding power, cloudiness (visual evaluation) and pinholes

| | Aluminum pigment | | | | Filament | Hiding | | |
|---|---|---|---|---|---|---|---|---|
| | | Particle size | | | length | power | | |
| WBL | Morphology | d50¹⁾ | [μm] | p/b²⁾ | [mm] | [μm] | Clouds | Pinholes |
| WBL17 | Cornflake | 19 | fine | 0.35 | 0.713 | 9 | 2-3 | 90 |
| WBL18 | Cornflake | 34 | coarse | 0.35 | 0.835 | 11 | 3-4 | 130 |
| WBL19 | Cornflake | 19 | fine | 0.13 | 0.829 | 14 | 3 | 120 |
| WBL20 | Cornflake | 34 | coarse | 0.13 | 0.874 | 16 | 3-4 | 160 |

¹⁾Characteristic data according to technical datasheet from Eckart
²⁾p/b = pigment/binder ratio

TABLE 6.6
Results of the investigations into hiding power, cloudiness (visual evaluation)

| | Aluminum pigment | | | | Filament | Hiding | |
|---|---|---|---|---|---|---|---|
| | | Particle size | | | length | power | |
| WBL | Morphology | d50¹⁾ | [μm] | p/b²⁾ | [mm] | [μm] | Clouds |
| WBL25 | Cornflake | 19 | fine | 0.25 | 0.685 | 10 | 2-3 |
| WBL26 | Cornflake | 34 | coarse | 0.25 | 0.791 | 12 | 3-4 |
| WBL27 | Cornflake | 19 | fine | 0.09 | 0.728 | 14 | 3 |
| WBL28 | Cornflake | 34 | coarse | 0.09 | 0.799 | 16 | 3-4 |

¹⁾Characteristic data according to technical datasheet from Eckart
²⁾p/b = pigment/binder ratio

TABLE 6.7
Results of the investigations into film thickness-dependent leveling

| | Aluminum pigment | | | | Filament | 10-15 μm | | 15-20 μm | | 20-25 μm | |
|---|---|---|---|---|---|---|---|---|---|---|---|
| | | Particle size | | | length | FT | | FT | | FT | |
| WBL | Morphology | d50¹⁾ | [μm] | p/b²⁾ | [mm] | SW | DOI | SW | DOI | SW | DOI |
| WBL9 | Cornflake | 16 | fine | 0.35 | 0.594 | 11.5 | 77.3 | 16.1 | 72.2 | 17.2 | 71.6 |
| WBL11 | Cornflake | 34 | coarse | 0.35 | 0.775 | 14.7 | 64.6 | 19.9 | 63.8 | 24.0 | 60.8 |
| WBL10 | Cornflake | 16 | fine | 0.13 | 0.717 | 8.6 | 85.1 | 11.9 | 83.8 | 14.3 | 82.7 |
| WBL12 | Cornflake | 34 | coarse | 0.13 | 0.821 | 10.4 | 74.3 | 15.1 | 71.4 | 18.7 | 68.4 |

¹⁾Characteristic data according to technical datasheet from Eckart
²⁾p/b = pigment/binder ratio

TABLE 6.8
Results of the investigations into film thickness-dependent leveling

| | Aluminum pigment | | | | Filament | 15-20 μm | | 20-25 μm | | 25-30 μm | |
|---|---|---|---|---|---|---|---|---|---|---|---|
| | | Particle size | | | length | FT | | FT | | FT | |
| WBL | Morphology | d50¹⁾ | [μm] | p/b²⁾ | [mm] | SW | DOI | SW | DOI | SW | DOI |
| WBL13 | Cornflake | 16 | fine | 0.25 | 0.579 | 20.6 | 70.4 | 25.1 | 62.8 | 26.1 | 62.2 |
| WBL15 | Cornflake | 34 | coarse | 0.25 | 0.678 | 23.1 | 61.9 | 25.3 | 56.6 | 26.1 | 53.6 |
| WBL14 | Cornflake | 16 | fine | 0.09 | 0.703 | 14.1 | 18.4 | 20.4 | 76.1 | 23.8 | 72.2 |
| WBL16 | Cornflake | 34 | coarse | 0.09 | 0.769 | 19.6 | 68.8 | 21.7 | 67.1 | 24.5 | 63.1 |

¹⁾Characteristic data according to technical datasheet from Eckart
²⁾p/b = pigment/binder ratio

TABLE 6.9
Results of the investigations into cloudiness

| | Aluminum pigment | | | | Filament | | | |
|---|---|---|---|---|---|---|---|---|
| | | Particle size | | | length | | | |
| WBL | Morphology | d50¹⁾ | [μm] | p/b²⁾ | [mm] | Mottling15 | Mottling45 | Mottling60 |
| WBL9 | Cornflake | 16 | fine | 0.35 | 0.594 | 3.8 | 4.2 | 4.1 |
| WBL11 | Cornflake | 34 | coarse | 0.35 | 0.775 | 3.4 | 5.3 | 4.9 |
| WBL10 | Cornflake | 16 | fine | 0.13 | 0.717 | 2.9 | 4.4 | 3.5 |
| WBL12 | Cornflake | 34 | coarse | 0.13 | 0.821 | 4.8 | 4.4 | 6.3 |

¹⁾Characteristic data according to technical datasheet from Eckart
²⁾p/b = pigment/binder ratio

In all of the cases investigated (with different pigment contents in each case), a replacement of the effect pigment used, particularly in relation to its lower particle size (based on the d50 of the pigment), results in shorter mean filament lengths at the bell edge. This consequently finer atomization is beneficial for the hiding power, the clouding propensity, and also pinholes and the leveling (SW and DOI).

6.5 Comparison Between Waterborne Basecoat Materials WBL17 to WBL24 and WBL29 and WBL30 with Regard to Clouding Propensity and Pinholes (Effect of the Pigment Fraction)

The investigations on waterborne basecoat materials WBL17 to WBL24 and WBL29 and WBL30 with regard to clouding propensity and pinholes were made in accordance with the methods described above. Illustrated specifically in this case is how it is possible to influence the atomization and the resultant coating properties via the amount of the aluminum pigments used. In all of the experiments the discharge rate was 300 ml/min; the rotational speed of the ESTA bell was 43 000 rpm. Tables 6.10 and 6.11 summarize the results.

TABLE 6.10
Results of the investigations into pinholes

| | Aluminum pigment | | | | Filament | |
|---|---|---|---|---|---|---|
| | | Particle size | | | length | |
| WBL | Morphology | d50¹⁾ | [μm] | p/b²⁾ | [mm] | Pinholes |
| WBL17 | Cornflake | 19 | fine | 0.35 | 0.713 | 90 |
| WBL19 | Cornflake | 19 | fine | 0.13 | 0.829 | 120 |
| WBL18 | Cornflake | 34 | coarse | 0.35 | 0.835 | 130 |
| WBL20 | Cornflake | 34 | coarse | 0.13 | 0.874 | 160 |
| WBL21 | Silver dollar | 12 | fine | 0.35 | 0.735 | 90 |
| WBL22 | Silver dollar | 12 | fine | 0.13 | 0.832 | 140 |
| WBL23 | Silver dollar | 24 | coarse | 0.35 | 0.720 | 80 |
| WBL24 | Silver dollar | 24 | coarse | 0.13 | 0.743 | 100 |

¹⁾Characteristic data according to technical datasheet from Eckart
²⁾p/b = pigment/binder ratio

TABLE 6.11
Results of the investigations into cloudiness

| | Aluminum pigment | | | | Filament | |
|---|---|---|---|---|---|---|
| | | Particle size | | | length | |
| WBL | Morphology | d50¹⁾ | [μm] | p/b²⁾ | [mm] | Clouds |
| WBL29 | Silver dollar | 9 | fine | 0.25 | 0.634 | 2 |
| WBL30 | Silver dollar | 9 | fine | 0.09 | 0.717 | 3 |

¹⁾Characteristic data according to technical datasheet from Eckart
²⁾p/b = pigment/binder ratio

In the comparison of the respective pairs of samples differing only in terms of the pigment/binder ratio, in other words with regard to the amount of pigment, it was found that an increase in the amount of the aluminum pigment used resulted in better atomization (lower filament length) and that this had a positive effect on pinholes and the susceptibility to clouding.

6.6 Comparison Between Waterborne Basecoat Materials WBL17 or WBL17a and Also WBL21 or WBL21a with Regard to Pinholes (Effect of Spray Viscosity or Amount of Water)

The investigations on waterborne basecoat materials WBL17 or WBL17a and also WBL21 or WBL21a with regard to pinholes were made in accordance with the method described above.

Illustrated specifically in this case is how the atomization and the resultant coating properties can be influenced via the adjusted spray viscosity (i.e., via the amount of water added). In all of the experiments, the discharge rate was 300 ml/min; the rotational speed of the ESTA bell was 43 000 rpm. Table 6.12 summarizes the results.

TABLE 6.12
Results of the investigations into pinholes

| | Spray viscosity | Filament | |
|---|---|---|---|
| WBL | [mPa · s]¹⁾ | length [mm] | Pinholes |
| WBL17 | 80 | 0.713 | 90 |
| WBL17a | 120 | 0.829 | 120 |
| WBL21 | 80 | 0.835 | 130 |
| WBL21a | 120 | 0.874 | 160 |

The examples demonstrate that by means of a lower spray viscosity during the atomization of the material, shorter filaments are generated at the bell edge, with beneficial consequences for the pinhole sensitivity.

6.7 Comparison Between Waterborne Basecoat Materials WBL32 and WBL33 and Also WBL34 and WBL35, or WBL34a and WBL35a, with Regard to Wetness

The investigations on waterborne basecoat materials WBL32 and WBL33 and also WBL34 and WBL35, or WBL34a and WBL35a, with regard to wetness were made in accordance with the method described above. Illustrated specifically in this case is how the atomization and the resultant wetness, which is responsible for properties such as cloudiness, pinhole robustness, etc., can be influenced via an additional amount of a co-binder (polyester), but especially of a solvent. The experiments on samples WBL32 and WBL33 were carried out at an ESTA bell rotational speed of 63 000 rpm, those on samples WBL34 and WBL35 and, respectively, WBL34a and WBL35a at 43 000 rpm and 63 000 rpm. In all cases the discharge rate was 300 ml/min. Tables 6.13 and 6.14 summarize the results.

TABLE 6.13
Results of the investigations into wetness

| | Filament | |
|---|---|---|
| WBL | length [mm] | Wetness |
| WBL32 | 0.585 | 2 |
| WBL33 | 0.865 | 4 |

With an increased amount used of a mixture of a polyester (prepared as per example D, column 16, lines 37-59 of DE 40 09 858 A1) and butyl glycol by two thirds (WBL33 in comparison to WBL32), the atomization found is significantly poorer, evidenced by a greater filament length at the bell edge, and is manifested in a significantly higher wetness.

TABLE 6.14
Results of the investigations into wetness

| | Rotational | Spray | Filament | |
|---|---|---|---|---|
| | speed | viscosity | length | |
| WBL | [rpm] | mPa · s]¹⁾ | [mm] | Wetness |
| WBL34 | 63 000 | 120 | 0.639 | 2 |
| WBL35 | 63 000 | 120 | 1.403 | 5 |
| WBL34a | 63 000 | 80 | 0.664 | 2 |
| WBL35a | 63 000 | 80 | 0.992 | 4 |
| WBL34 | 43 000 | 120 | 0.835 | 2 |
| WBL35 | 43 000 | 120 | 1.331 | 5 |
| WBL34a | 43 000 | 80 | 0.760 | 2 |
| WBL35a | 43 000 | 80 | 0.914 | 4 |

For both discharge rates (63 000 rpm and 43 000 rpm) it was found, for the respective pairs of samples adjusted to the same spray viscosity (120 mPa·s or 80 mPa·s), that by adding butyl glycol an influence is exerted over the filament length and hence also the wetness, which is a cause, for example, of the sensitivity to clouding or to pinholes; the solvent produces a significant prolongation of the filaments at the bell during atomization, and therefore a significantly wetter film deposited.

6.8 The examples demonstrate that by means of the method of the invention it is possible to make predictions about the atomization of a paint that correlate with qualitative properties of the final coating (number of pinholes, wetness, cloudiness or leveling, and appearance and hiding power) and in particular correlate better than other methods in the prior art. The method of the invention therefore enables a simple and efficient method for quality assurance. It may help to focus paint developments and in so doing to remove the need at least partly for costly and inconvenient coating operations on model substrates (including baking of the materials).

### 7. Investigations on Clearcoat Materials and the Resultant Films and Coatings

### Comparison Between Clearcoats KL1, KL1a and KL1b in Relation to Running Limits

The investigations on clearcoats KL1 and KL1a and also KL1b in relation to their running behavior were made in accordance with the method described above. Illustrated specifically in this case is how the running behavior can be influenced via the spray viscosity, which is adapted by the addition of a solvent, and also via the omission of additives known to the skilled person such as rheology control agents. The materials involved are as follows:

### Clearcoat KL1

The sample KL1 is a commercial two-component clearcoat material (ProGloss from BASF Coatings GmbH) containing fumed silica as a rheological assistant (Aerosil® products from Evonik), with the base varnish having been adjusted using ethyl 3-ethoxypropionate to a viscosity of 100 mPa·s at 1000/s.

### Clearcoat KL1a

Sample KL1a corresponds to KL1, with the difference that the base varnish has been adjusted using ethyl 3-ethoxypropionate to a viscosity of 50 mPa·s at 1000/s.

### Clearcoat KL1b

Sample KL1b corresponds to KL1, with the difference that it contains no fumed silica as rheological assistant. The base varnish has likewise been adjusted using ethyl 3-ethoxypropionate, as in the case of KL, to a viscosity of 100 mPa·s at 1000/s.

The experiments were carried out on the samples at an ESTA bell rotational speed of 55 000 rpm. The discharge rate was 550 ml/min. Table 7.1 summarizes the results.

TABLE 7.1
Results of the investigations into running behavior

| | | Start of | Running |
|---|---|---|---|
| | Filament | runs (>0 | limit |
| | length | mm) | (>10 mm) |
| Clearcoat | [mm] | [μm] | [μm] |
| KL1 | 1.1 | 48 | 58 |
| KL1a | >KL1 | 38 | 44 |
| KL1b | 1.4 | 36 | 42 |

In the case of KL1b, the mean filament lengths ascertained were longer than in the case of KL1. The same is true of KL1a: here as well, the mean filament lengths ascertained were longer than in the case of KL1.

The results therefore demonstrate that by means of receptive measures such as reducing the spray viscosity (KL1a) or eliminating the rheological assistants based on fumed silica (KL1b), in comparison to the reference KL1, the atomization may be impaired (longer filaments at the bell edge during the atomization procedure), with the consequence in each case of a deterioration in the running stability.

The examples demonstrate that by means of the method of the invention it is possible, in particular also for clearcoat materials, to make predictions about the atomization of a paint that correlate with qualitative properties of the final coating (for example, run behavior) and in particular correlate better than other methods in the prior art. The method of the invention therefore enables a simple and efficient method for quality assurance. It may help to focus paint developments and in so doing to remove the need at least partly for costly and inconvenient coating operations on model substrates (including baking of the materials).

1. A method for determining the mean length of filaments formed on rotational atomization of a coating material composition, the method comprising:
(1) atomization of a coating material composition by means of a rotational atomizer comprising as application element a bell cup capable of a rotation,
(2) optical capture of the filaments formed on atomization as per step (1) at the bell cup edge, by means of at least one camera, and
(3) digital evaluation of the optical data obtained by the optical capture as per step (2), to give the mean length of those filaments formed on atomization that are located at the edge of the bell cup.

2. The method according to claim 1, wherein the coating material composition used in step (1) is an aqueous basecoat material.

3. The method according to claim 1, wherein the coating material composition used in step (1) comprises at least one polymer employable as binder, as a component (a); at least one pigment and/or at least one filler, as a component (b); and water and/or at least one organic solvent, as a component (c).

4. The method according to claim 3, wherein component (b) comprises at least one effect pigment in the coating material composition.

5. The method according to claim 1, wherein the atomization as per step (1) is carried out at a discharge rate of the coating material composition for atomization in a range from 100 to 1000 ml/min and/or at a rotary speed of the bell cup in a range from 15,000 to 70,000 revolutions/min.

6. The method according to claim 1, wherein the optical capture as per step (2) takes place by the at least one camera recording 30,000 to 250,000 images of the bell cup and of the bell cup edge per second during the atomization.

7. The method according to claim 1, wherein the digital evaluation as per step (3) takes place by means of image analysis and/or video analysis of the optical data obtained as per step (2).

8. The method according to claim 1, wherein the digital evaluation as per step (3) is carried out on the basis of at least 1000 images captured as per step (2).

9. The method according to claim 1, wherein the digital evaluation as per step (3) comprises:
(3a) smoothing of the images obtained as optical data after implementation of step (2), by means of a Gaussian filter, to remove the bell cup from the images,
(3b) binarization and inverting of the images smoothed as per stage (3a),
(3c) binarization of the images used in stage (3a) and addition of the images thus binarized to the inverted images from stage (3b), to give binarized images without bell cup edge, and inverting of the images thus obtained,
(3d) removal of drops, fragmented filaments, and filaments not located at the bell cup edge from the images obtained as per stage (3c), to give images on which all of the located objects remaining are filaments,
(3e) removal, from the images obtained as per stage (3d), of those filaments not located entirely within the images, and
(3f) tapering of all filaments remaining in the images after stage (3e) to their number of pixels, addition of the number of pixels for each of the filaments, determination of the filament length of each of the filaments on the basis of the pixel size, and ascertainment of the mean filament length for the entirety of all filaments measured.

10. The method according to claim 9, wherein the removal as per stage (3d) is accomplished by (i) determination of the length of all hypotenuses of all objects located on the images, (ii) labeling of objects as drops and/or fragmented filaments on the images if the hypotenuse values ascertained for these objects fall below a defined value h, and elimination of these objects, and (iii) verification of the remaining objects, namely the filaments, on the basis of their position on the images, as to whether they were located at the bell cup edge, and elimination of those filaments to which this does not apply.

11. A method for compiling and/or updating an electronic database containing mean filament lengths of atomized coating material compositions which differ from one another, the method comprising:
steps (1), (2), and (3) as defined in claim 1 for a first coating material composition (i),
(4A) incorporation of the mean filament length, ascertained as per step (3) for the first coating material composition (i), into an electronic database, and
(5A) repetition at least once of the steps (1) to (3) and (4A) for at least one further coating material composition, different from the first coating material composition (i).

12. The method according to claim 11, further comprising:
(3A) application of the first coating material composition (i) atomized in step (1) to a substrate, to form a film located on the substrate, and baking of this film to form a coating located on the substrate,
(3B) analysis and assessment of the coating obtained after step (3A) for the incidence or nonincidence of surface defects and/or optical defects, and
(3C) incorporation of the results obtained after implementation of step (3B) into the electronic database,
where step (5A) comprises the repetition at least once of these steps (3A), (3B), and (3C) for the at least one further coating material composition, different from the first coating material composition (i).

13. A method for screening coating material compositions in the development of paint formulations, the method comprising:
steps (1), (2), and (3) as defined in claim 1 for a coating material composition (X1),
(4B) comparison of the mean filament length, determined as per step (3) for the coating material composition (X1), with mean filament lengths of further coating material compositions, stored in an electronic database, said database being obtainable by means of a method comprising:
steps (1), (2), and (3) as defined in claim 1 for a first coating material composition (i),
(4A) incorporation of the mean filament length, ascertained as per step (3) for the first coating material composition (i), into an electronic database, and
(5A) repetition at least once of the steps (1) to (3) and (4A) for at least one further coating material composition, different from the first coating material composition (i),
(5B) checking, on the basis of the comparison as per step (4B), as to whether the mean filament length, determined as per step (3) for the coating material composition (X1), meets the condition that it is lower than at least one mean filament length stored in the database of a coating material composition (X2), which is different from the coating material composition (X1) but has a pigment content identical to that of the coating material composition (X1) or has a pigment content deviating by no more than ±10% by weight from the pigment content of the coating material composition (X1), based on the amount of pigment present in the coating material composition (X1), and which, moreover, comprises the identical pigment or pigments or the substantially identical pigment or pigments to the coating material composition (X1),
(6B) selection of the coating material composition (X1) for application to a substrate, if the mean filament length determined for the coating material composition (X1) meets the condition specified in step (5B),
or
adaptation of at least one parameter within the formula of the coating material composition (X1) and/or of at least one method parameter when performing steps (1) to (3) of the method for screening coating material compositions, if the mean filament length determined for the coating material composition (X1) does not meet the condition specified in step (5B),
(7B) repetition at least once of steps (1) to (3), (4B), and (5B), if as per step (6B) at least one parameter adaptation is required, until, according to an implementation of step (6B), repeated at least once, owing to the meeting of the condition stated in step (5B), the coating material composition used is selected for application to a substrate.

14. The method according to claim 13, wherein the adaptation of at least one parameter within the formula of the coating material composition (X1) and/or of at least one method parameter in the implementation of steps (1) to (3) as per step (6B) comprises at least one adaptation selected from the group of adaptations of the following parameters:
(i) raising or lowering the amount of at least one polymer present as binder component (a) in the coating material composition (X1),
(ii) at least partially replacing at least one polymer present as binder component (a) in the coating material composition (X1) by at least one polymer different thereto,
(iii) raising or lowering the amount of at least one pigment and/or filler present as component (b) in the coating material composition (X1), this being possible, for pigments present therein, only within the above-stated boundaries,
(iv) at least partially replacing at least one filler present as component (b) in the coating material composition (X1) by at least one filler different thereto,
(v) raising or lowering the amount of at least one organic solvent present as component (c) in the coating material composition (X1), and/or of water present therein,
(vi) at least partially replacing at least one organic solvent present as component (c) in the coating material composition (X1) by at least one organic solvent different thereto,
(vii) raising or lowering the amount of at least one additive present as component (d) in the coating material composition (X1),
(viii) at least partially replacing at least one additive present as component (d) in the coating material composition (X1) by at least one additive different thereto, and/or adding at least one further additive different thereto,
(ix) changing the sequence of the components used for preparing the coating material composition (X1), and/or
(x) raising or lowering the energy input of the mixing when preparing the coating material composition (X1).

15. The method according to claim 13, wherein the method is a method for screening aqueous basecoat materials which comprise at least one effect pigment as a component (b).
